(19) United States
(12) Patent Application Publication
(10) Pub. No.: US 2012/0068831 A1
(43) Pub. Date: Mar. 22, 2012

(54) WIRELESS TAG WRITING/READING APPARATUS AND METHOD BY THE SAME

(75) Inventor: Takahiro Shimura, Shizuoka (JP)

(73) Assignee: TOSHIBA TEC KABUSHIKI KAISHA, Tokyo (JP)

(21) Appl. No.: 13/222,743

(22) Filed: Aug. 31, 2011

(30) Foreign Application Priority Data
Sep. 21, 2010 (JP) 2010-211457

(51) Int. Cl. G06K 7/01

(52) U.S. Cl. 340/10.42; 340/10.52

(57) ABSTRACT

Certain embodiments provide a wireless tag writing apparatus including: a generation unit configured to generate an identification code to be written in a wireless tag having a memory storing data, the identification code identifying an object attached with the wireless tag; an adding unit configured to calculate the identification code according to a determination type code representing a type of a determination method for confirming whether there is any garbled bit occurring in the identification code, and add a generated check code resultant from calculation according to the determination method to the identification code; and a communication unit configured to communicate with the wireless tag, and write the identification code, the determination type code, and the check code to the memory of the wireless tag.

### CROSS-REFERENCE TO RELATED APPLICATION

The present application is based upon and claims the benefit of priority from the Japanese Patent Application No. 2010-211457, filed on 21th Sep., 2010, the entire content of which is incorporated herein by reference.

### FIELD

An embodiment relates to a wireless tag writing apparatus, a wireless tag reading apparatus, and a data writing/reading method performed by a wireless tag writing/reading apparatus.

### BACKGROUND

A wireless tag reading apparatus wirelessly communicates with a wireless tag called an IC (integrated circuit) tag or an RFID (radio frequency identification) tag. The wireless tag reading apparatus uses a modulated wireless signal to transmit information to a wireless tag. The wireless tag reading apparatus keeps on transmitting a non-modulated signal after transmission of information is finished. In response, the wireless tag performs backscatter modulation by changing the amount of reflection of the non-modulated signal transmitted from the wireless tag reading apparatus, thus transmitting information to the wireless tag reading apparatus. The wireless tag reading apparatus receives the backscatter-modulated wave to read information in the wireless tag.

For example, the wireless tags use data structure defined in EPC global RFID air interface specification and the like. As shown in FIG. 24A, a memory of the wireless tag has ID (Identification) information (hereinafter referred to as EPC data) unique to an object to which the wireless tag is attached. The ID information is referred to as EPC (Electronic product code). When the wireless tag reading apparatus transmits a response request, the wireless tag replies data having the data structure as shown in FIG. 24B to the wireless tag reading apparatus. The data include header information indicating a length of data called a PC (Protocol Control), EPC data, and a CRC-16 (Cyclic Redundancy Check 16) code for detecting communication errors.

When the wireless tag is activated, the wireless tag calculates a CRC-16 code for EPC data having a length specified by a PC stored in the wireless tag, and stores the CRC-16 code to the memory of the wireless tag. The wireless tag outputs the CRC-16 code as well as the EPC data.

As shown in FIG. 25, the wireless tag reading apparatus detects a preamble of response data of the wireless tag (act 401). The wireless tag reading apparatus receives the PC (act 402), receives the EPC data (act 403), and receives the CRC-16 code (act 404) in order. After receiving the CRC-16 code, the wireless tag reading apparatus causes a CRC-16 determination unit to calculate a CRC-16 code for the PC and EPC[0] to EPC [/N−1] data (act 405). The wireless tag reading apparatus compares the CRC-16 code obtained as the result and the received CRC-16 code, thereby calculating a CRC-16 error check (act 405). The wireless tag reading apparatus determines the correctness of the read data. When the result of determination indicates that there is no error, the wireless tag reading apparatus processes the data as being correct (act 406). When an error is detected, the wireless tag reading apparatus processes the data as being incorrect (act 407).

A memory in a wireless tag is mainly a nonvolatile memory called a flash memory. The flash memory may have a garbled bit, which is considered to be caused by degradation of a memory cell over time. The garbled bit is a phenomenon that logic 0 of data in the memory changes to logic 1, or on the contrary logic 1 changes to logic 0.

In the related art, when a logic of data changes due to an external noise during communication, the wireless tag reading apparatus calculates an error check of CRC-16. The wireless tag reading apparatus can determine correctness of the data and detect incorrect data.

However, when the garbled bit occurs in the memory of the wireless tag, the wireless tag calculates a CRC-16 code for the incorrect data including the garbled bit during activation process. The wireless tag reading apparatus can calculate an error check of CRC-16, but cannot determine the correctness of the data including the garbled bit.

### BRIEF DESCRIPTION OF THE DRAWINGS

FIG. 1A is a functional block diagram illustrating a configuration of a wireless tag writing apparatus according to a first embodiment;

FIG. 1B is a configuration block diagram illustrating a configuration of a wireless tag used in the wireless tag writing apparatus according to the first embodiment;

FIG. 2A is a figure illustrating a data structure in a memory of a wireless tag used in the wireless tag writing apparatus according to the first embodiment;

FIG. 2B illustrates transmission data transmitted from the wireless tag writing apparatus according to the first embodiment to the wireless tag and response data transmitted from the wireless tag to the wireless tag reading apparatus;

FIG. 3 is table figure illustrating a plurality of determination types including determination methods performed by the wireless tag writing apparatus according to the first embodiment;

FIG. 4 is a figure illustrating examples of a confirmation check method performed by the wireless tag writing apparatus according to the first embodiment;

FIG. 5A is a flowchart figure illustrating data generation including addition of a check code performed by the wireless tag writing apparatus according to the first embodiment;

FIG. 5B is a flowchart figure illustrating data reception including determination of correctness performed by the wireless tag reading apparatus according to the first embodiment;

FIG. 6A is a figure illustrating a data structure in a memory in a wireless tag used in a wireless tag writing apparatus according to a second embodiment;

FIG. 6B is a figure illustrating response data transmitted from the wireless tag to the wireless tag reading apparatus according to the second embodiment;

FIG. 7 is a figure illustrating examples of a confirmation check method performed by the wireless tag writing apparatus according to the second embodiment;

FIG. 8A is a flowchart figure illustrating a data generation including addition of a check code performed by the wireless tag writing apparatus according to the second embodiment;

FIG. 8B is a flowchart figure illustrating data reception including determination of correctness performed by the wireless tag reading apparatus according to the second embodiment;

FIG. 9A is a figure illustrating a data structure in a memory of a wireless tag used in a wireless tag writing apparatus according to a third embodiment;

FIG. 9B is a figure illustrating response data transmitted from the wireless tag to a wireless tag reading apparatus according to the third embodiment;

FIG. 10 is a figure illustrating examples of a confirmation check method performed by the wireless tag writing apparatus according to the third embodiment;

FIG. 11A is a flowchart figure illustrating data generation including addition of a check code performed by the wireless tag writing apparatus according to the third embodiment;

FIG. 11B is a flowchart figure illustrating data reception including determination of correctness performed by the wireless tag reading apparatus according to the third embodiment;

FIG. 12A is a figure illustrating a data structure in a memory of a wireless tag used in a wireless tag writing apparatus according to a fourth embodiment;

FIG. 12B is a figure illustrating response data transmitted from the wireless tag to a wireless tag reading apparatus according to the fourth embodiment;

FIG. 13 is a figure illustrating examples of a confirmation check method performed by the wireless tag writing apparatus according to the fourth embodiment;

FIG. 14A is a flowchart figure illustrating data generation including addition of a check code performed by the wireless tag writing apparatus according to the fourth embodiment;

FIG. 14B is a flowchart figure illustrating data reception including determination of correctness performed by the wireless tag reading apparatus according to the fourth embodiment;

FIG. 15A is a figure illustrating a data structure in a memory of a wireless tag used in a wireless tag writing apparatus according to a fifth embodiment;

FIG. 15B is a figure illustrating a response data structure transmitted from the wireless tag to a wireless tag reading apparatus according to the fifth embodiment;

FIG. 16 is a figure illustrating examples of a confirmation check method performed by the wireless tag writing apparatus according to the fifth embodiment;

FIG. 17A is a flowchart figure illustrating a data generation flow including addition of a check code performed by the wireless tag writing apparatus according to the fifth embodiment;

FIG. 17B is a flowchart figure illustrating a data reception flow including determination of correctness performed by the wireless tag reading apparatus according to the fifth embodiment;

FIG. 18A is a figure illustrating a data structure in a memory of a wireless tag used in a wireless tag writing apparatus according to a sixth embodiment;

FIG. 18B is a figure illustrating response data transmitted from the wireless tag to a wireless tag reading apparatus according to the sixth embodiment;

FIG. 19 is a figure illustrating examples of a confirmation check method performed by the wireless tag writing apparatus according to the sixth embodiment;

FIG. 20A is a flowchart figure illustrating data generation including addition of a check code performed by the wireless tag writing apparatus according to the sixth embodiment;

FIG. 20B is a flowchart figure illustrating a data reception flow including determination of correctness performed by the wireless tag reading apparatus according to the sixth embodiment;

FIG. 21A is a figure illustrating a data structure in a memory of a wireless tag used in a wireless tag writing apparatus according to a seventh embodiment;

FIG. 21B is a figure illustrating response data transmitted from the wireless tag to a wireless tag reading apparatus according to the seventh embodiment;

FIG. 22 is a figure illustrating examples of a confirmation check method performed by the wireless tag writing apparatus according to the seventh embodiment;

FIG. 23A is a flowchart figure illustrating a data generation flow including addition of a check code performed by the wireless tag writing apparatus according to the seventh embodiment;

FIG. 23B is a flowchart figure illustrating a data reception flow including determination of correctness performed by the wireless tag reading apparatus according to the seventh embodiment;

FIG. 24A is a figure illustrating a memory configuration of a wireless tag and a data configuration in a memory of a response according to a related art;

FIG. 24B is a figure illustrating a memory configuration of a wireless tag and response data of a wireless tag of a response according to the related art; and

FIG. 25 is a figure illustrating a reception flow of a reading apparatus according to the related art.

### DETAILED DESCRIPTION

Certain embodiments provide a wireless tag writing apparatus including: a generation unit configured to generate an identification code to be written in a wireless tag having a memory storing data, the identification code identifying an object attached with the wireless tag; an adding unit configured to calculate the identification code according to a determination type code representing a type of a determination method for confirming whether there is any garbled bit occurring in the identification code, and add a generated check code resultant from calculation according to the determination method to the identification code; and a communication unit configured to communicate with the wireless tag, and write the identification code, the determination type code, and the check code to the memory of the wireless tag.

Hereinafter, a wireless tag writing apparatus, a wireless tag reading apparatus, and a data writing/reading method performed by a wireless tag writing/reading apparatus according to embodiments will be explained with reference to drawings. In each drawing, the same portions are denoted with the same reference numerals, and such portions are not repeatedly explained.

### First Embodiment

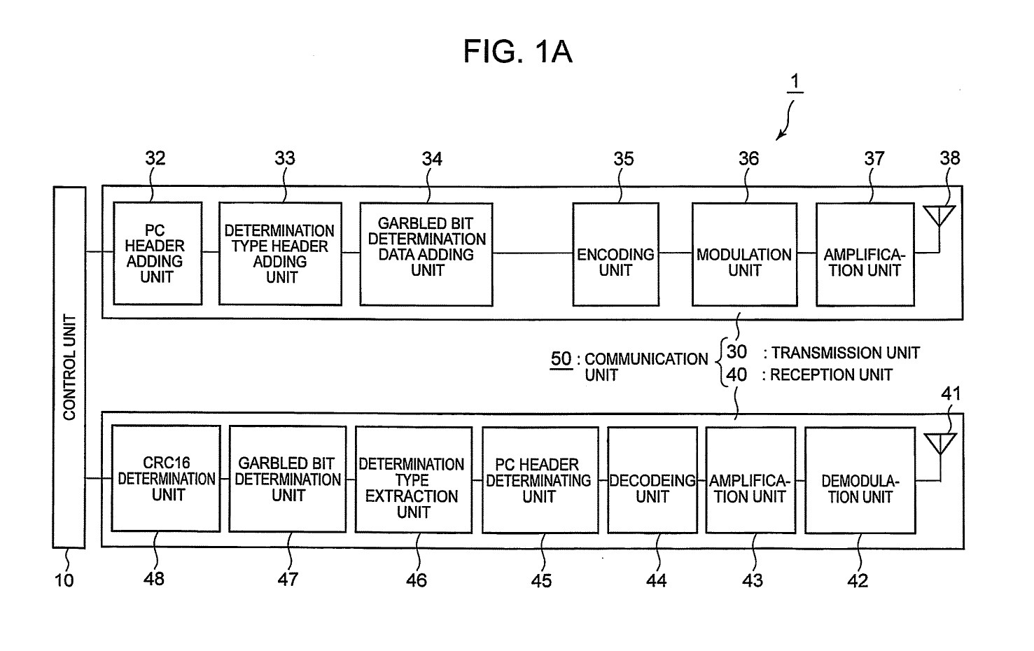

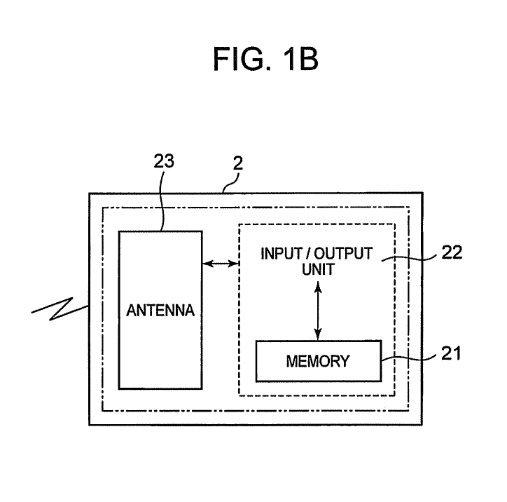

FIG. 1A is a block diagram illustrating a configuration of a wireless tag writing/(and) reading apparatus (hereinafter referred to as a reader writer) 1. FIG. 1B is a block diagram illustrating a configuration of a wireless tag 2. The reader writer 1 includes a control unit 10 for controlling an apparatus body, a transmission unit 30, and a reception unit 40.

The control unit 10 includes a CPU (Central Processing Unit) and a memory, and is configured to operate according to a program stored in advance.

The wireless tag 2 includes a memory 21 storing data, an input/output unit 22 for generating an error check code explained later based on data stored in the memory 21 and inputting/outputting data to/from the reader writer 1, and an antenna 23 for wirelessly communicating with the reader writer 1.

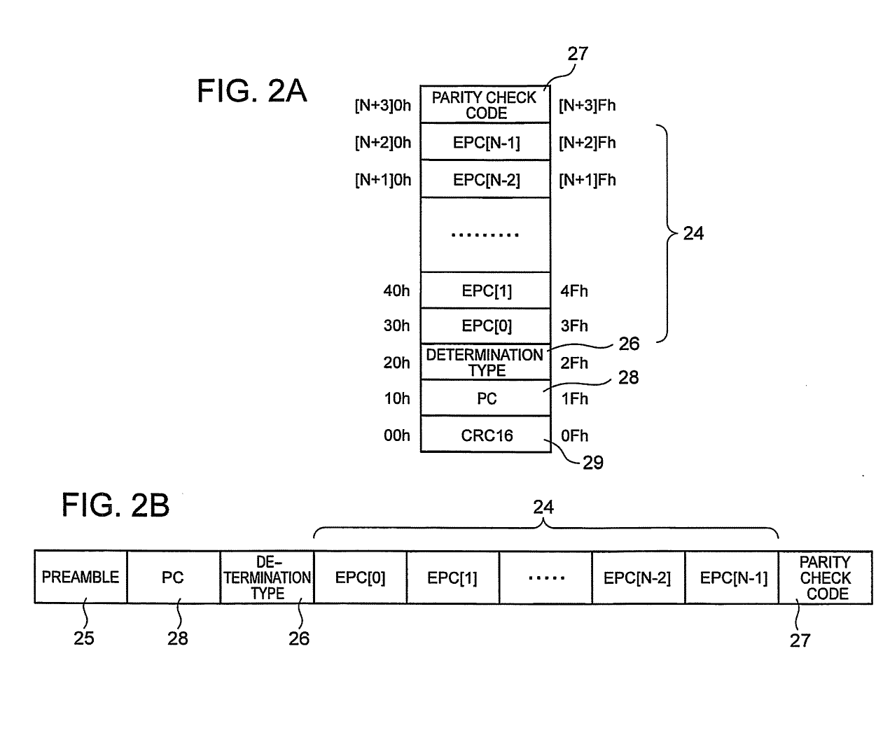

When the data are transmitted to the wireless tag 2, the transmission unit 30 of the reader writer 1 prepares EPC data 24 as shown in FIG. 2B. The EPC data 24 are identification codes, and have a data structure including N words, i.e., EPC [0] to EPC [/N−1].

The PC header adding unit 32 adds a preamble 25 to the EPC data 24, and adds a data length PC (PC) 28 before the EPC data 24. The data length PC 28 has (N+2) words. The data length PC 28 includes the EPC data 24 having N words, a determination type code 26 having one word indicating the type of specified determination explained later, and a parity check code 27 having one word generated by a determination method (determination scheme) corresponding to the type of determination.

In other words, the PC header adding unit 32 functions as a generation unit of the EPC data 24. The PC header adding unit 32 has a function of adding the data length PC 28 to the EPC data 24.

The determination type header adding unit 33 adds a determination type code 26 having one word before the EPC data 24. The determination type code 26 represents the type of determination for confirming whether there is any garbled bit in the EPC data 24 stored in the memory 21 of the wireless tag 2. The first embodiment shows an example in which a determination as to whether there is any garbled bit or not is made using a type of determination, i.e., calculating parity checks of all the data.

The garbled bit determination data adding unit 34 generates a parity check code 27 from the data length PC 28 added by the PC header adding unit 32, a determination type code 26 added by the determination type header adding unit 33, and the EPC data 24, and adds the parity check code 27 to the last portion of the EPC data 24. The garbled bit determination data adding unit 34 generates transmission data transmitted to the wireless tag 2.

The garbled bit determination data adding unit 34 is an adding unit that calculates the EPC data 24 using the determination type code 26, and adds the parity check code 27 generated as a result of the calculation to the EPC data 24.

The input/output unit 22 of the wireless tag 2 functions as an output unit. The input/output unit 22 outputs the EPC data 24, the determination type code 26, and the parity check code stored in the memory 21 in response to a read request from the reader writer 1.

An encoding unit 35 encodes the transmission data thus generated. A modulation unit 36 modulates a carrier wave in baseband. An amplification unit 37 amplifies modulated transmission data, and the amplified transmission data are transmitted from the antenna 38 to the wireless tag 2 as a wireless signal.

The control unit 10 has a communication control function. The transmission unit 30, the reception unit 40, and the control unit 10 function as a communication unit 50 for wirelessly communicating with the wireless tag 2. The communication unit 50 writes the EPC data 24, the determination type code, and the parity check code 27 to the memory 21 of the wireless tag 2.

The data string transmitted to the wireless tag 2 is as shown in FIG. 2B.

The wireless tag 2 receives the data from the reader writer 1. The wireless tag 2 removes the preamble 25 from the data string received by the input/output unit 22. The wireless tag 2 stores the obtained, received data string to the addresses 10h to [N+3]Fh (h indicates a hexadecimal number) of the memory 21 as shown in FIG. 2A.

In this example, the memory 21 stores the data in unit of one word (2 bytes). When the wireless tag 2 is activated by the reader writer 1, the wireless tag 2 calculates a CRC check code 29 (check code) for the data having the word length specified by the data length PC 28. Hereinafter, an example will be explained in which the parity bit length is 16. The CRC check code 29 may also be referred to as CRC-16. The wireless tag 2 stores the CRC-16 data 29 in addresses 00h to 0Fh. This CRC-16 is used for error check during communication from the wireless tag 2 to the reader writer 1.

The wireless tag 2 stores the data length information PC 28 in addresses 10h to 1Fh. The data length information PC 28 indicates a total word length of the data length information PC 28 itself, the determination type code 26, the EPC data 24, and the parity check code 27. The wireless tag 2 stores the determination type code 26 in addresses 20h to 2Fh. The determination type code 26 represents the type of determination for determining whether there is any garbled bit occurring in the data in the memory 21. The wireless tag 2 stores the EPC data 24 having N words, i.e., EPC [0] to EPC [/N−1], in the address 30h and addresses subsequent thereto. The wireless tag 2 stores the parity check code 27 in addresses [N+3] 0h to [N+3] Fh.

In other words, the addresses 00h to 0Fh constitute a first region of the memory 21. For example, a parity bit of CRC-16 defined in advance according to the air interface specification is stored in addresses 00h to 0Fh. Addresses 10h to [N+3] constitute a second region. The addresses 10h to [N+3] are separated from the addresses 00h to 0Fh. The garbled bit determination data adding unit 34 writes the determination type code 26 and the parity check code 27 to addresses 10h to [N+3].

On the other hand, when the reader writer 1 transmits a read command of data to the wireless tag 2, the wireless tag 2 reads data as soon as the wireless tag 2 is activated. The wireless tag 2 generates CRC-16 for the data from the data length PC 28 to the parity check code 27 in the memory 21. The wireless tag 2 stores the CRC-16 in the addresses 00h to 0Fh of the memory 21.

Thereafter, the wireless tag 2 adds CRC-16 data 29 at the last of the data string as shown in FIG. 2B. The wireless tag 2 transmits the obtained data to the reader writer 1 as a response signal. The reception unit 40 of the reader writer 1 includes an antenna 41 for receiving a response signal from the wireless tag 2, a demodulation unit 42 for demodulating the response signal given by the wireless tag 2 into a baseband signal using a local signal, an amplification unit 43 for amplifying the demodulated baseband signal, and a decoding unit 44 for decoding the response data of the wireless tag 2 from the amplified baseband. The reception unit 40 further includes a PC header determination unit 45 for determining the length of the data provided by the wireless tag 2 and a determination type extraction unit 46 for extracting the determination type code 26 for determining whether there is any garbled bit occurring in the data string read from the wireless tag 2.

The determination type extraction unit 46 is a reading unit. The determination type extraction unit 46 reads the EPC data 24, the determination type code 26, and the parity check code (first check code) from the wireless tag 2 based on the received data. The wireless tag 2 generates the parity check code by calculating the EPC data 24 according to the determination type code.

Further, the reception unit 40 has a garbled bit determination unit 47. The garbled bit determination unit 47 uses the determination type code 26 extracted by the determination type extraction unit 46 to generate a parity check code (second check code) for the data length PC 28, the determination type code 26, and the EPC data 24 in the data string read from the wireless tag 2. The garbled bit determination unit 47 determines a garbled bit by comparing the generated parity check code with the parity check code 27 (first check code) read from the wireless tag 2. The garbled bit determination unit 47 determines correctness of the EPC data 24. In other words, the garbled bit determination unit 47 functions as a generation unit and a determination unit.

Further, the reception unit 40 includes a CRC determination unit (CRC-16 determination unit) 48. The CRC determination unit 48 generates CRC-16 for the data from the data length PC 28 to the parity check code 27 in the data string read from the wireless tag 2. The CRC determination unit 48 calculates an error check during data communication by comparing the CRC-16 with the CRC-16 data 29 read from the wireless tag 2.

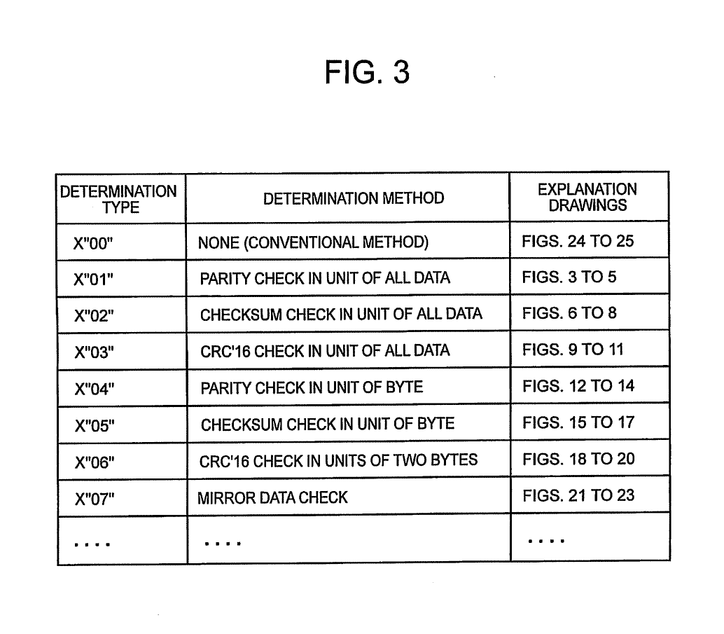

A major difference of the present embodiment from related art lies in that the determination type header adding unit 33, the garbled bit determination data adding unit 34, the determination type extraction unit 46, and the garbled bit determination unit 47 are provided in FIG. 1. For example, as shown in FIG. 3, the determination type code 26 for determining whether there is any garbled bit and the determination method thereof in the determination type header adding unit 33 and the garbled bit determination unit 47 are defined in advance as shown in FIG. 3.

Subsequently, the actions of the above configuration will be explained.

When the reader writer 1 writes data to the wireless tag 2, the reader writer 1 specifies a type of used determination from among the determination types shown in FIG. 3. According to the type of determination thus specified, the determination type header adding unit 33 adds the determination type code 26 to the EPC data 24, and a parity check code 27 generated for the data length PC 28, the determination type code 26, and the EPC data 24 according to the type of determination is added to the EPC data 24. Then, they are transmitted to the wireless tag 2 and written therein.

On the other hand, when the reader writer 1 reads the data in the wireless tag 2, the reader writer 1 extracts the determination type code 26 from the data string read from the wireless tag 2. The reader writer 1 generates a parity check code for the data length PC 28, the determination type code 26 and the EPC data 24 in the data string read from the wireless tag 2. The parity check code is obtained as a result of generation according to the extracted determination type code. The reader writer 1 compares the generated parity check code with the parity check code 27 read from the wireless tag 2. When the parity check codes of them both match each other as a result of the comparison, the reader writer 1 can confirm that there is no garbled bit occurring in the memory of the wireless tag 2.

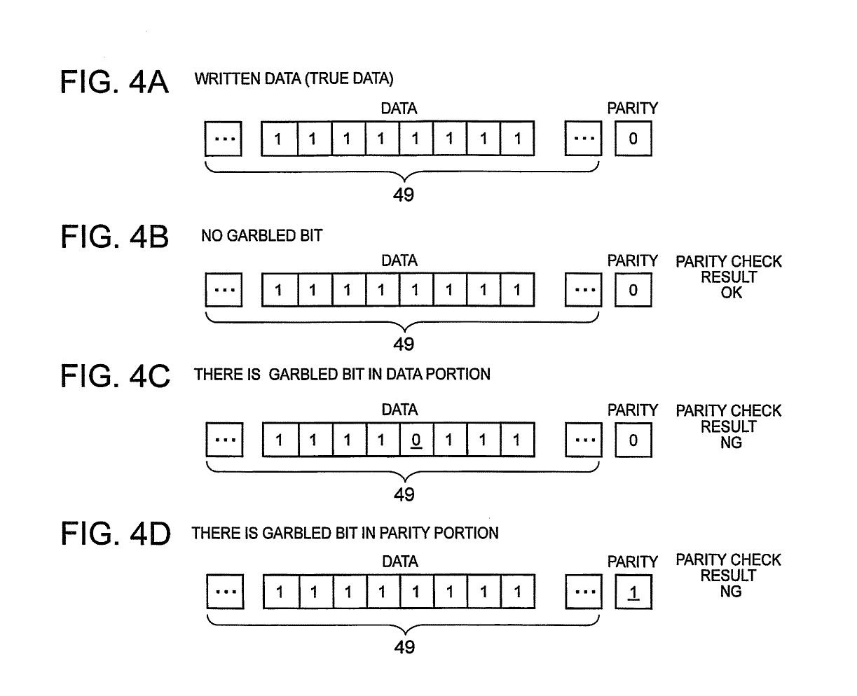

FIGS. 4A to 4D show a specific example of a check method when the parity check is specified as the type of determination. The range 49 represents all the range including the data length PC 28, the determination type code 26, and the EPC data 24.

FIG. 4A illustrates an example of a confirmation check method by generating a parity check code when the reader writer 1 writes data to the wireless tag 2. The reader writer 1 generates the parity check code. The reader writer 1 generates 0 as a parity check code when data to be transmitted have an even number of “1” bits. The data to be transmitted indicates the data length PC 28, the determination type code 26, and the EPC data 24. The reader writer 1 generates 1 as a parity check code when data to be transmitted, i.e., the data length PC 28, the determination type code 26, and the EPC data 24, have an odd number of “1” bits. In the example of FIG. 4A, there are eight bits whose value is “1” in a range 49 indicated by parentheses. The parity check code is 0.

FIGS. 4B to 4D show examples of a determination method for determining whether there is any garbled bit or not when the reader writer 1 reads data from the wireless tag 2. In the example of FIG. 4B, when the reader writer 1 counts the number of bits in the range 49, the result is assumed to be as follows: the number of bits whose value is 1 is 8, and the parity check code is assumed to be 0. As shown in FIG. 4B, when no garbled bit occurs, the parity check code calculated for the received data matches the parity check code 27 read from the wireless tag 2. The received data indicates the data length PC 28, the determination type code 26, and the EPC data 24. The parity check result is OK.

On the other hand, when there is a garbled bit occurring in the received data, i.e., the data length PC 28, the determination type code 26, and the EPC data 24, the calculated parity check code does not match the received parity check code 27. The reader writer 1 determines that a garbled bit occurs.

FIG. 4C shows an example in which the parity check code 27 is not matched as a result of a garbled bit occurring in the portion of the EPC data 24. When the reader writer 1 counts the number of bits in the range 49, the result is assumed to be as follows: the number of bits whose value is 1 is 7, and the parity check code is assumed to be 1. Thus the parity check result is NG. FIG. 4D shows an example in which the parity check code is not matched as a result of a garbled bit occurring in the portion of the parity check code 27. In FIG. 4D, the count result in the range 49 is as follows. There are eight bits whose value is “1”, and the parity check code is 0. The parity check result is NG.

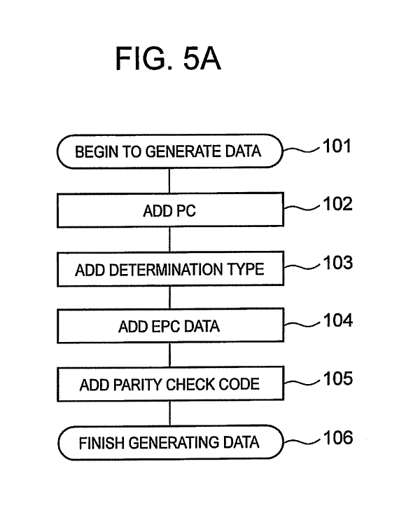

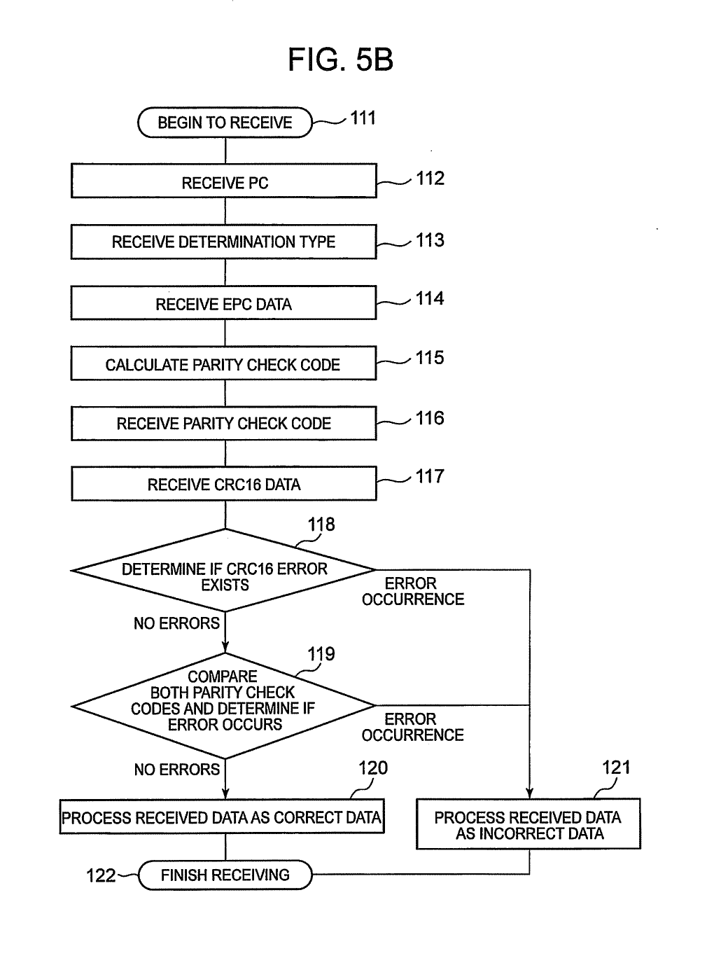

FIG. 5A is a flowchart in which data to be written are generated when the reader writer 1 writes the data to the wireless tag 2. First, the transmission unit 30 calculates a word length of the data length PC 28, the determination type code 26, and the EPC data 24 (act 101). The transmission unit 30 adds, as the data length PC 28, the word length to the data to be transmitted (act 102). Subsequently, the transmission unit 30 adds, to the data string, the determination type code 26 serving as the determination type for determining whether there is any garbled bit in accordance with a correspondence table shown in FIG. 3 (act 103). In the present embodiment, since this is a parity check, the determination type code 26 is X″01″.

Subsequently, the transmission unit 30 adds the EPC data 24 to the data string (act 104). The transmission unit 30 calculates a parity check code 27 for the data length PC 28, the determination type code 26, and the EPC data 24. Finally, the reader writer 1 adds the parity check code 27 to the data string (act 105). The reader writer 1 completes generation of the data to be written to the wireless tag 2 (act 106).

FIG. 5B is a flowchart in which the reader writer 1 receives response data from the wireless tag 2, and determines whether there is any garbled bit. The reception unit 40 begins to receive (act 111).

First, the reception unit 40 receives the data length PC 28 (act 112), and determines the word length of the data received from the wireless tag 2. Subsequently, the reception unit 40 receives the determination type code 26 (act 113). The reception unit 40 selects the type of determination for determining whether there is any garbled bit in accordance with the correspondence table of FIG. 3. Subsequently, after the EPC data 24 are received, the reception unit 40 calculates a parity check code for the data length PC 28, the determination type code 26, and the EPC data 24 (act 115). Thereafter, the reception unit 40 receives the parity check code (act 116), and receives CRC-16 (act 117). After the reception, the reception unit 40 calculates a CRC-16 error check (act 118).

When a CRC-16 error occurs in the act 118, the reception unit 40 processes the received data as incorrect data (act 121), and terminates the reception (act 122). On the other hand, when there is no CRC-16 error, the reception unit 40 compares the calculated parity check code with the received parity check code 27 (act 119). When the calculated parity check code is the same as the received parity check code 27, the reception unit 40 processes the received data as correct data including no garbled bit (act 120), and terminates the reception (act 122). On the other hand, when the parity check is not matched, the reception unit 40 processes the received data as incorrect data including a garbled bit (act 121), and terminates the reception.

As described above, when the reader writer 1 writes data to the wireless tag, the reader writer 1 adds the code representing the determination type for determining there is any garbled bit and the check code generated by the type of determination to the data and writes the data. The reader writer 1 generates a check code on the basis of the determination type code read from the wireless tag when the data are read from the wireless tag. The reader writer 1 compares the generated check code with the check code read from the wireless tag, thereby determining whether there is any garbled bit occurring in the memory of the wireless tag.

### Second Embodiment

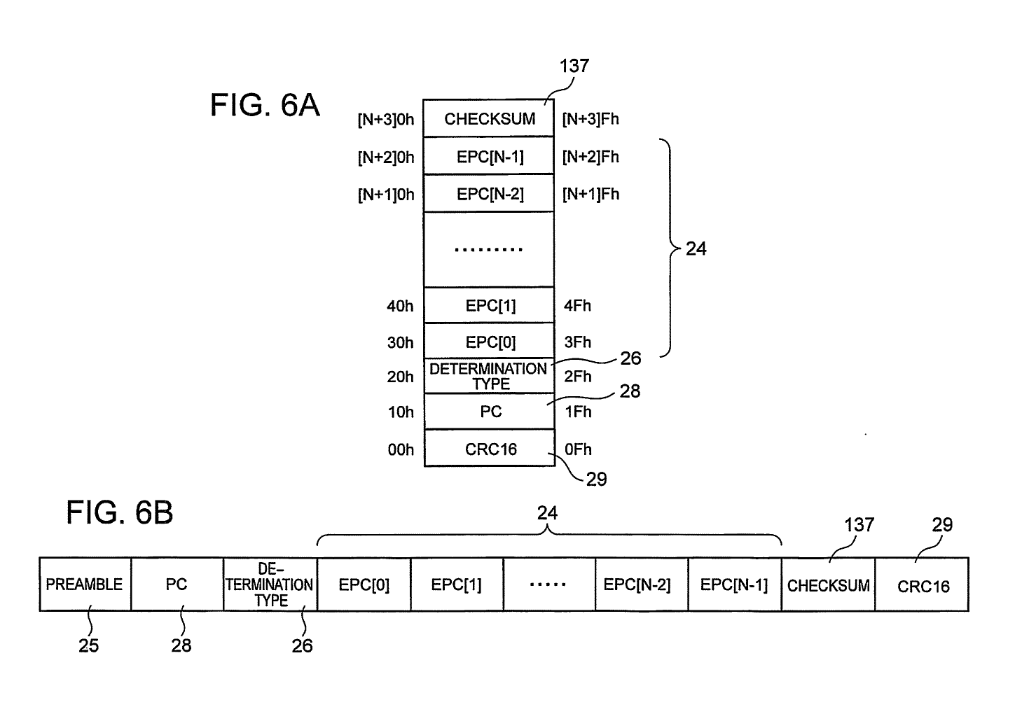

Subsequently, the second embodiment will be explained with reference to FIGS. 6 to 8. The second embodiment shows an example in which a checksum check for all the data is calculated, and a determination is made as to whether there is any garbled bit.

The wireless tag writing apparatus and the wireless tag reading apparatus according to the present embodiment have substantially the same configuration as the configuration of the reader writer 1 according to the first embodiment unless specifically mentioned.

FIG. 6A illustrates a data structure in a memory 21 in a wireless tag 2. In this example, the memory 21 records the data in unit of one word (2 bytes). The memory 21 stores a CRC-16 data 29 in the addresses 00h to 0Fh. The wireless tag 2 calculates the CRC-16 data 29 when the wireless tag 2 is activated. The reader writer 1 and the wireless tag 2 calculate the CRC-16 data 29 for data having a word length specified by a data length PC 28. The reader writer 1 and the wireless tag 2 use the CRC-16 data 29 as CRC-16 error check during communication. The memory 21 stores the data length PC 28 in addresses 10h to 1Fh. The data length PC 28 indicates a total word length of the data length PC 28 itself, a determination type code 26, an EPC data 24, and a checksum check code 137 (check code). The memory 21 stores the determination type code 26 in addresses 20h to 2Fh. The determination type code 26 represents a determination method for determining whether there is any garbled bit. The memory 21 stores EPC data 24 having N words, i.e., EPC [0] to EPC[N−1], in the address 30h and addresses subsequent thereto. The memory 21 stores a checksum check code 137 in addresses [N+3]0h to [N+3]Fh. The reader writer 1 and the wireless tag 2 calculate the checksum check code 137 for the data length PC 28, the determination type code 26, and the EPC data 24.

In reply to a response request such as a read-out command transmitted from the reader writer 1, the wireless tag 2 replies the preamble 25 and then the data stored in the memory 21 as shown in FIG. 6B.

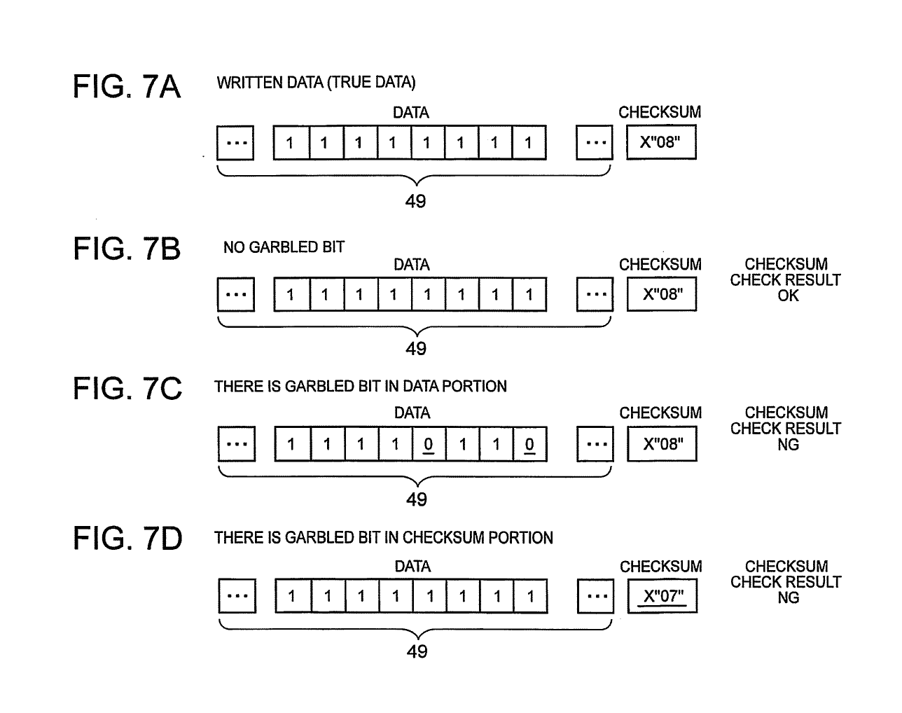

FIG. 7A illustrates an example of a confirmation check method by generating the checksum check code 137 when the reader writer 1 writes data to the wireless tag 2. The reader writer 1 counts the number of bits whose value is “1” in data to be transmitted. Data to be transmitted indicates i.e. the data length PC 28, the determination type code 26, and the EPC data 24. The reader writer 1 generates thus obtained resultant number of bits as the checksum check code 137. The reader writer 1 generates data such that the number of bits whose value is “1” is 8 in a range 49 and the value of the checksum is 8.

FIGS. 7B to 7D show examples of a determination method for determining whether there is any garbled bit or not when the reader writer 1 reads data from the wireless tag 2. As shown in FIG. 73, when no garbled bit occurs, the checksum check code calculated for the received data matches the received checksum check code 137. The received data indicates the data length PC 28, the determination type code 26, and the EPC data 24. When the reader writer 1 counts the number of bits in the range 49, the result is assumed to be as follows: the number of bits whose value is 1 is 8, and the value of the checksum is assumed to be 8. The checksum check result is OK.

On the other hand, when there is a garbled bit occurring in the received data, i.e., the data length PC 28, the determination type code 26, and the EPC data 24, the calculated checksum check code does not match the received checksum check code 137. The reception unit 40 determines that there is a garbled bit.

As shown in FIG. 7C, the calculated checksum check code does not match the checksum code 137 received from the wireless tag 2 as a result of a garbled bit occurring in the portion of the EPC data 24. When the reader writer 1 counts the number of bits in the range 49, the result is assumed to be as follows: the number of bits whose value is 1 is 7. The reader writer 1 is assumed to calculate the checksum as 7. Thus the checksum check result is NG. FIG. 7D shows an example in which the calculated checksum check code is not matched as a result of a garbled bit occurring in the portion of the checksum check code 137 received from the wireless tag 2. In the range 49, the number of bits whose value is 1 is assumed to be 8. The value of the checksum is assumed to be 8. The checksum check result is NG.

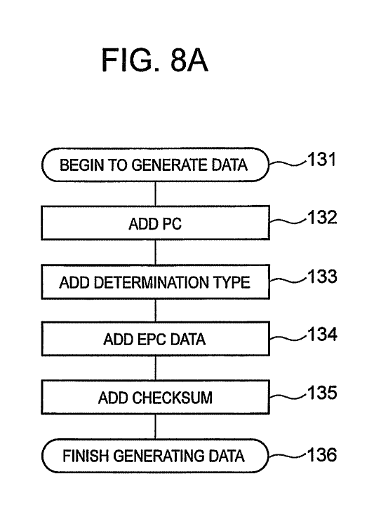

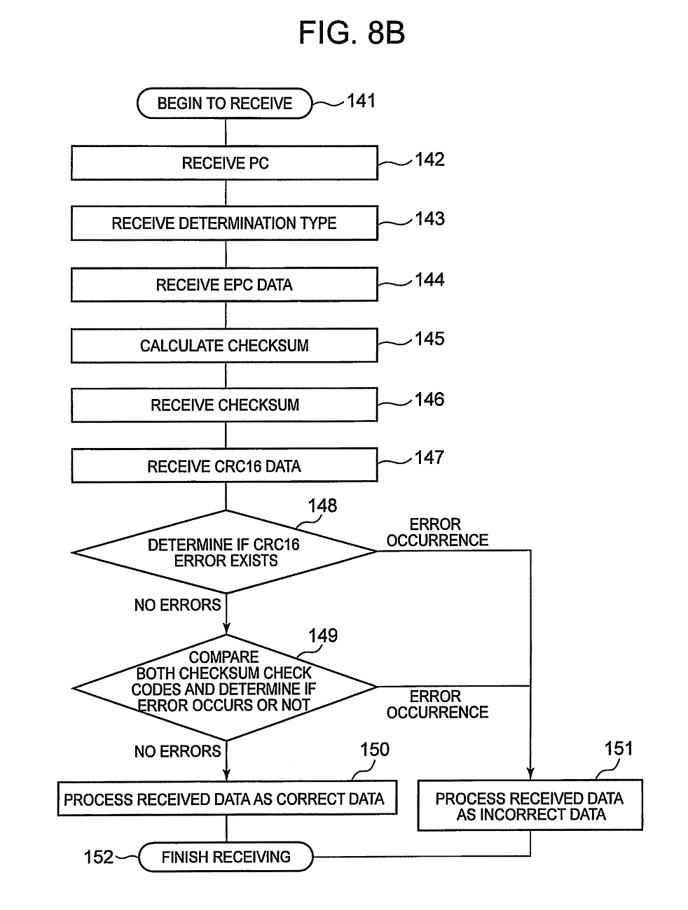

FIG. 8A is a flowchart in which data to be written are generated when the reader writer 1 writes the data to the wireless tag 2.

First, the header adding unit 32 starts data generation (act 131). The header adding unit 32 calculates a word length of the data length PC 28, the determination type code 26, the EPC data 24, and the checksum check code 137. The transmission unit 30 adds, as the data length PC 28, the word length to the data to be transmitted (act 132). Subsequently, the transmission unit 30 adds, to the data, the determination type code 26 serving as the determination method for determining whether there is any garbled bit, specified in accordance with a correspondence table shown in FIG. 3 (act 133). In the present embodiment, the determination type code is X″ 02″. Subsequently, the transmission unit 30 adds the EPC data 24 to the data (act 134). Finally, the transmission unit 30 calculates a checksum check code 137 for the data length PC 28, the determination type code 26, and the EPC data 24 (act 135). The reader writer 1 adds the checksum check code 137 to the data (act 135). The reader writer 1 completes generation of the data to be written to the wireless tag 2 (act 136).

FIG. 8B is a flowchart in which the reader writer 1 receives response data from the wireless tag 2, and determines whether there is any garbled bit.

First, the reader writer 1 receives the data length PC 28 from the wireless tag 2 (acts 141, 142). The reception unit 40 determines the word length of the data to be replied from the wireless tag 2. Subsequently, the reception unit 40 receives the determination type code 26 in act 143. The reception unit 40 extracts the type of determination for determining whether there is any garbled bit in accordance with the correspondence table of FIG. 3 (act 143). Subsequently, the reception unit 40 receives the EPC data 24 (act 144). After the reception, the reception unit 40 calculates a checksum check code for the data length PC 28, the determination type code 26, and the EPC data 24 (act 145). Thereafter, the reception unit 40 receives the checksum check code 137 (act 146). After the reception unit 40 receives the CRC-16 data 29 (act 147), the reception unit 40 calculates a CRC-16 error check (act 148). When a CRC-16 error occurs here, the reception unit 40 processes the received data as incorrect data (act 151). The reader writer 1 finishes reception (act 152).

On the other hand, when there is no CRC-16 error, the reception unit 40 compares the checksum check code obtained from calculation with the received checksum check code 137 (act 149). When the checksum check code obtained from calculation matches the received checksum check code 137, the reception unit 40 processes the data as correct data in which there is no garbled bit (act 150), and the reception unit 40 finishes the reception. When the checksum check code is not matched, the reception unit 40 processes the received data as incorrect data including a garbled bit (act 151), and the reader writer 1 terminates the reception.

In the present embodiment, the data length PC 28 and the determination type code 26 are in separate words (2 bytes). Alternatively, both of them may be accommodated in the same word. For example, the determination type code 26 may be included in the data length PC 28. The reader writer 1 may store the length information indicating the word length in a high byte of the data length PC 28 and store the determination type code 26 in a low byte thereof.

### Third Embodiment

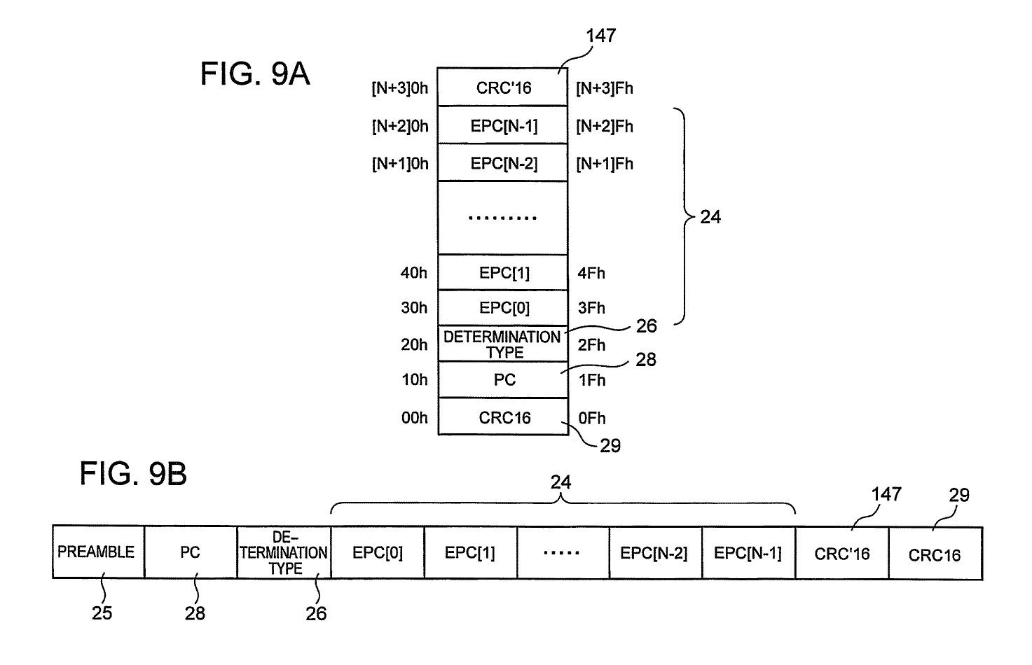

Subsequently, the third embodiment will be explained with reference to FIGS. 9 to 11. The third embodiment shows an example in which a CRC′ 16 check for all the data is calculated, and a determination is made as to whether there is any garbled bit. In this case, the description of CRC′ 16 is used such that it is distinguished from the CRC-16 which the wireless tag 2 calculates for data in the memory 12 of the wireless tag 2 during activation.

The wireless tag writing apparatus and the wireless tag reading apparatus according to the present embodiment have substantially the same configuration as the configuration of the reader writer 1 according to the first embodiment unless specifically mentioned.

FIG. 9A illustrates a data structure in a memory 21 in a wireless tag 2. In this example, the memory 21 records the data in unit of one word (2 bytes). The memory 21 stores CRC-16 data 29 in the addresses 00h to 0Fh. The wireless tag 2 calculates the CRC-16 data 29 when the wireless tag 2 is activated. The reader writer 1 and the wireless tag 2 calculate the CRC-16 data 29 for data having a word length specified by a data length PC 28. The reader writer 1 uses the CRC-16 data 29 for CRC-16 error check during communication. The memory 21 stores the data length PC 28 in the addresses 10h to 1Fh. The data length PC 28 indicates a total word length of the data length PC 28 itself, the determination type code 26, the EPC data 24, and a CRC′ 16 data 147. The memory 21 stores the determination type code 26 in addresses 20h to 2Fh. The determination type code 26 represents a determination method for determining whether there is any garbled bit. The memory 21 stores EPC data 24 having N words, i.e., EPC [0] to EPC [N−1], in the address 30h and addresses subsequent thereto. The memory 21 stores the CRC′ 16 data 147 in addresses [N+3] 0h to [N+3] Fh. The reader writer 1 and the wireless tag 2 can be obtained by calculating the CRC′ 16 data 147 for data including the data length PC 28, the determination type code 26, and the EPC data 24.

In this kind of data structure, in reply to a response request such as a read-out command transmitted from the reader writer 1, the wireless tag 2 replies the preamble 33 and then the data stored in the memory 21 as shown in FIG. 9B.

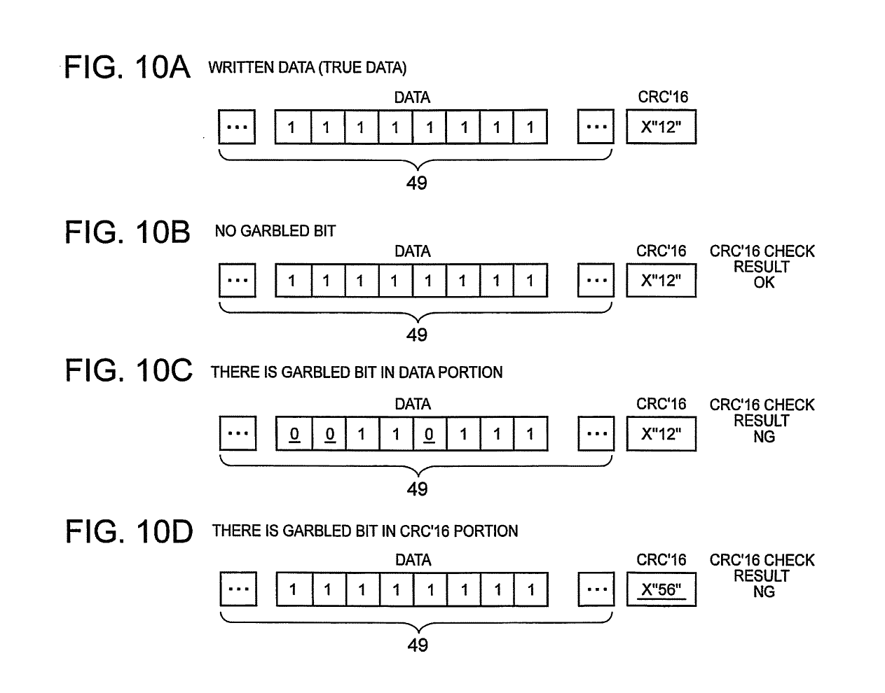

FIG. 10A illustrates an example of a confirmation check method for generating a CRC′ 16 data 147 when the reader writer 1 writes data to the wireless tag 2. The reader writer 1 generates the CRC′ 16 for data to be transmitted using a well-known technique. Data to be transmitted indicates the data length PC 28, the determination type code 26, and the EPC data 24. In FIG. 10A, in a range 49, a value with a frame named CRC′ 16 is assumed to be X″12″. It should be noted that the value of the CRC′ 16 shown in FIGS. 10A to 10D is an exemplary value for the sake of explanation, and is not calculated by the reader writer 1.

FIGS. 10B to 10D show examples of a determination method for determining whether there is any garbled bit or not when the reader writer 1 reads data from the wireless tag 2. The value of the CRC′ 16 calculated by the reader writer 1 from the bits in the range 49 of FIG. 10B is assumed to be X″ 12″. As shown in FIG. 10B, when no garbled bit occurs, the CRC′ 16 calculated for the received data matches the CRC′ 16 data 147 received from the wireless tag 2. The received data indicates the data length PC 28, the determination type code 26, and the EPC data 24. The CRC′ 16 check result is OK.

On the other hand, when there is a garbled bit occurring in the received data, i.e., the data length PC 28, the determination type code 26, and the EPC data 24, the calculated CRC′ 16 do not match the received CRC′ 16 data 147. Therefore, the reader writer 1 determines that there is a garbled bit. FIG. 10C shows a case in which the CRC′ 16 is not matched as a result of a garbled bit occurring in the portion of the EPC data 24. The value of the CRC′ 16 calculated by the reader writer 1 from the bits in the range 49 of FIG. 10C is assumed to be X″34″. Thus the CRC′ 16 check result is NG. FIG. 10D shows a case in which the CRC′ 16 is not matched as a result of a garbled bit occurring in the portion of the CRC′ 16 data 147 received from the wireless tag 2. The value of the CRC′ 16 calculated by the reader writer 1 from the bits in the range 49 of FIG. 10D is assumed to be X″12″. The CRC′ 16 check result is NG.

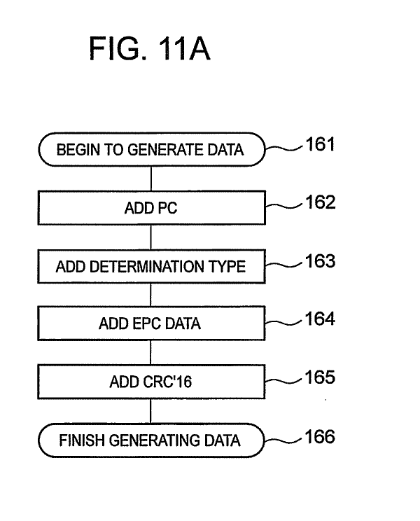

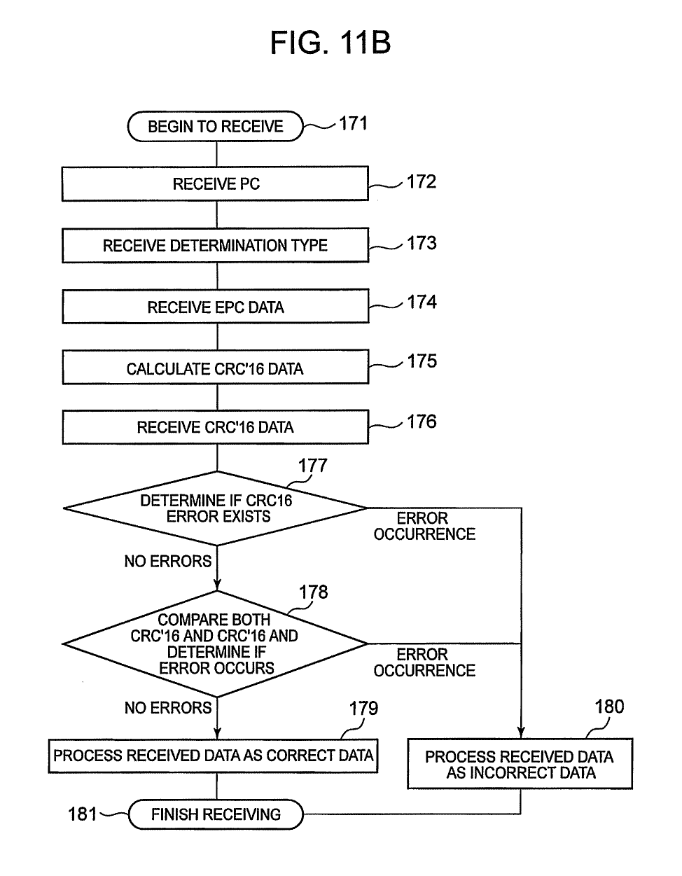

FIG. 11A is a flowchart in which data to be written are generated when the reader writer 1 writes the data to the wireless tag 2.

First, the transmission unit 30 starts data generation (act 161. The transmission unit 30 calculates a word length of the data length PC 28, the determination type code 26, the EPC data 24, and the CRC′ 16 data 147, and adds, as the data length PC 28, the word length to the data to be transmitted (act 162). Subsequently, the transmission unit 30 adds, to the data, the determination type code 26 serving as the determination method for determining whether there is any garbled bit, in accordance with the type of determination specified based on the correspondence table shown in FIG. 3 (act 163). In the present embodiment, the determination type code 26 is X″03″. Subsequently, the transmission unit 30 adds the EPC data 24 to the data (act 164). Finally, the transmission unit 30 calculates a CRC′ 16 for the data length PC 28, the determination type code 26, and the EPC data 24 (act 165). The transmission unit 30 adds the calculated CRC′ 16 to the data (act 165). The reader writer 1 completes generation of the data to be written to the wireless tag 2 (act 166).

FIG. 11B is a flowchart in which the reader writer 1 receives response data from the wireless tag 2, and determines whether there is any garbled bit.

First, the reception unit 40 receives the data length PC 28 from the wireless tag 2 (acts 171, 172). The reception unit 40 determines the word length of the data to be replied from the wireless tag 2 (act 172). Subsequently, the reception unit 40 receives the determination type code 26 (act 173). The reception unit 40 selects a determination method for determining whether there is any garbled bit in accordance with the correspondence table of FIG. 3 (act 173). Subsequently, the reception unit 40 receives the EPC data 24 (act 174). After the reception, the reception unit 40 calculates a CRC′ 16 for the data length PC 28, the determination type code 26, and the EPC data 24 (act 175).

Thereafter, the reception unit 40 receives the CRC′ 16 data 147 (act 176), and performs the CRC-16 error check (act 177). When a CRC-16 error occurs here, the reception unit 40 processes the received data as incorrect data (act 180).

On the other hand, when there is no CRC-16 error, the reception unit 40 compares the CRC′ 16 calculated by the reception unit 40 with the received CRC′ 16 data 147 (act 178). When the calculated CRC′ 16 is the same as the received CRC′ 16 data 147, the reception unit 40 processes the received data as correct data including no garbled bit (act 179), and terminates the reception (act 181). When the CRC′ 16 is not matched in the comparison result of the CRC′ 16, the reception unit 40 processes the received data as incorrect data including a garbled bit (act 179), and the reader writer 1 terminates the reception (act 181).

### Fourth Embodiment

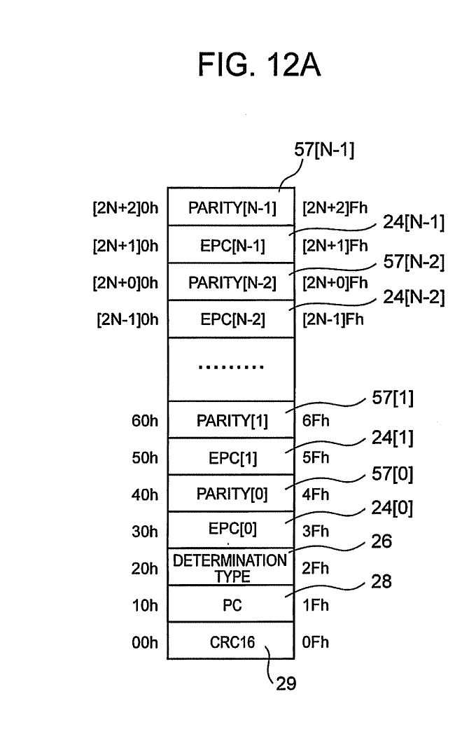

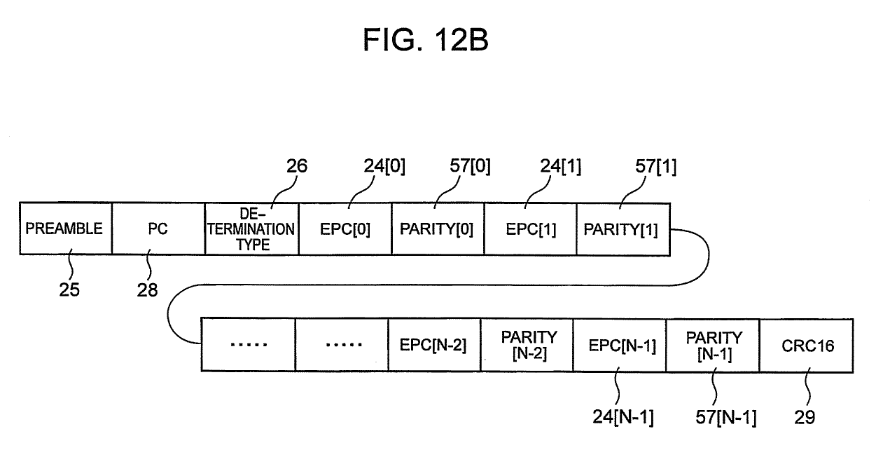

Subsequently, the fourth embodiment will be explained with reference to FIGS. 12 to 14. The fourth embodiment shows an example in which the parity check is performed in unit of one word (2 bytes), and a determination is made as to whether there is any garbled bit.

The wireless tag writing apparatus and the wireless tag reading apparatus according to the present embodiment have substantially the same configuration as the configuration of the reader writer 1 according to the first embodiment unless specifically mentioned.

FIG. 12A illustrates a data structure in a memory 21 in a wireless tag 2. In this example, the memory 21 records the data in unit of one word (2 bytes). The memory 21 stores CRC-16 data 29 in the addresses 00h to 0Fh. The wireless tag 2 calculates the CRC-16 data 29 when the wireless tag 2 is activated. The wireless tag 2 calculates the CRC-16 data 29 for data having a word length specified by a data length PC 28. The reader writer 1 and the wireless tag 2 use the CRC-16 data 29 as CRC-16 error check during communication. The memory 21 stores the data length PC 28 in the addresses 10h to 1Fh. The data length PC 28 indicates a word length of the data length PC 28 itself, the determination type code 26, EPC data 24 [0] to 24 [N−1] having N words, and all the parity check codes 57 [0] to 57 [N−1]. The memory 21 stores the determination type code 26 in addresses 20h to 2Fh. The determination type code 26 represents a determination method for determining whether there is any garbled bit. The memory 21 stores EPC[0] data in addresses 30h to 3Fh. The memory 21 stores the parity check code 57 [0] calculated for the EPC [0] data in addresses 40h to 4Fh. Likewise, the memory 21 stores EPC[N−1] data in addresses [2N+1]Oh to [2N+1]Fh. The memory 21 stores the parity check codes 57 [N−1] calculated for the EPC[N−1] data in the addresses [2N+2] Oh to [2N+2] Fh, respectively.

In this kind of data structure, in reply to a response request such as a read-out command transmitted from the reader writer 1, the wireless tag 2 outputs the preamble 25 and then the data stored in the memory 21 as shown in FIG. 12B.

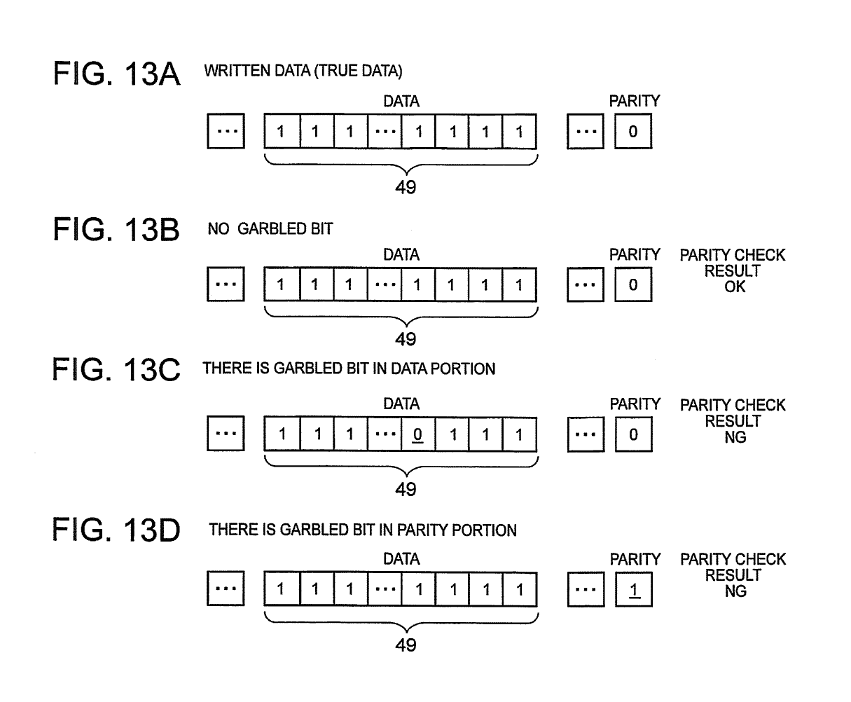

FIG. 13A illustrates an example of a confirmation check method for generating an even number parity check code 24 when the reader writer 1 writes data to the wireless tag 2. The reader writer 1 generates 0 as a parity check code when one word of the EPC data 24 to be transmitted have the number of bits whose value is 1 is an even number. The reader writer 1 generates 1 as a parity check code 57 when one word of the EPC data 24 to be transmitted have the number of bits whose value is 1 is an odd number. When the reader writer 1 counts the number of bits in the range 49, the result is assumed to be as follows: the number of bits whose value is 1 is 8, and the parity check code calculated by the reader writer 1 is assumed to be 0.

FIGS. 13B to 13D show examples of a determination method for determining whether there is any garbled bit or not when the reader writer 1 reads data from the wireless tag 2.

The reception result in the range 49 of FIG. 13B is assumed to be as follows. The number of bits whose value is 1 is assumed to be 8. The parity check code obtained by calculating the number of bits in the range 49 is assumed to be 0. As shown in FIG. 13B, when no garbled bit occurs, the parity check code calculated for one word of the received EPC data 24 matches the parity check code 57 received from the wireless tag 2. The parity check result is OK. On the other hand, when there is a garbled bit occurring in one word of the received EPC data 24, the calculated parity check code does not match the parity check code 57 received from the wireless tag 2. The reception unit 40 determines that there is a garbled bit.

FIG. 13C shows a case in which the parity check code 57 is not matched as a result of a garbled bit occurring in the portion of the EPC data 24. In the range 49, the number of bits whose value is 1 is assumed to be 7. The parity check code is assumed to be 1. The parity check result is NG. FIG. 13D shows a case in which the parity check code is not matched as a result of a garbled bit occurring in the portion of the parity check code 57 received from the wireless tag 2. In the range 49, the number of bits whose value is 1 is assumed to be 8. The parity check code is assumed to be 0. On the other hand, the parity check code in the received data is assumed to be 1. The parity check result is NG.

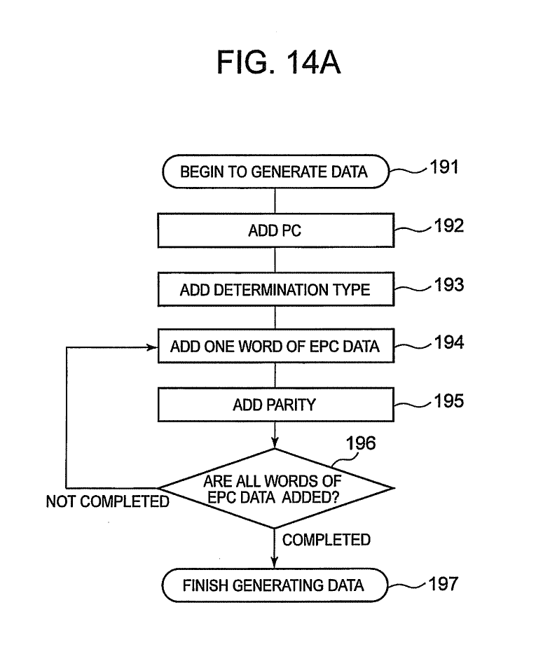

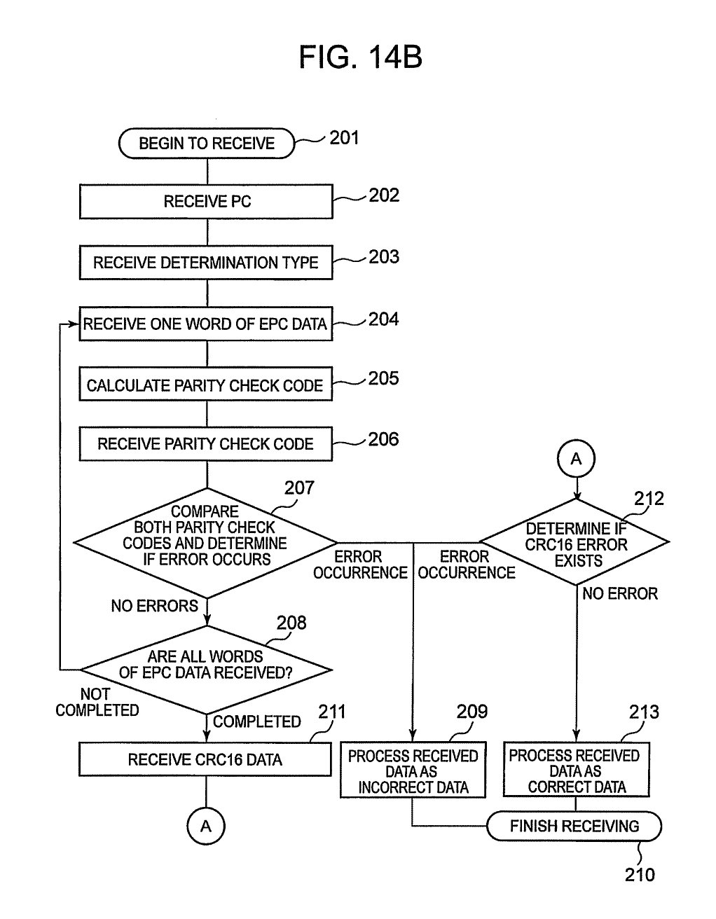

FIG. 14A is a flowchart in which data to be written are generated when the reader writer 1 writes the data to the wireless tag 2.

First, the transmission unit 30 calculates a word length of the data length PC 28, the determination type code 26, the EPC data 24 [0] to 24 [n−1] having N words, and the parity check codes 57 [0] to 57 [N−1] for respective words of the EPC data. The word length of the transmission unit 30 is added as the data length PC 28 (acts 191, 192). Subsequently, the transmission unit 30 adds the determination type code 26 serving as the determination method for determining whether there is any garbled bit, in accordance with the determination method specified based on the correspondence table shown in FIG. 3 (act 193).

Subsequently, the transmission unit 30 adds one word of EPC data 24 [0] to the data to be transmitted (act 194). The transmission unit 30 calculates the parity check code 57 [0] for the one word of EPC data 24[0]. The transmission unit 30 adds the calculated parity check code 57 [0] to the data (act 195). For all the words in the EPC data, the transmission unit 30 repeats calculation of the parity check code 57 and addition of the parity check code 57 to the data (act 196). The reader writer 1 completes generation of the data to be written to the wireless tag 2 (act 197). While the reader writer 1 does not yet complete data generation, via ‘NOT COMPLETED’ route, the reader writer 1 executes the act 194 process.

FIG. 143 is a flowchart in which the reader writer 1 receives response data from the wireless tag 2, and determines whether there is any garbled bit.

First, the reception unit 40 receives the data length PC 28 (acts 201, 202). The reception unit 40 determines the word length of the data to be replied from the wireless tag 2. Subsequently, the reception unit 40 receives the determination type code 26 (act 203). The reception unit 40 selects a determination method for determining whether there is any garbled bit in accordance with the correspondence table of FIG. 3.

Subsequently, the reception unit 40 receives one word of EPC data 24 [0] (act 204). After the reception unit 40 receives the one word of EPC data 24 [0], the reception unit 40 calculates a parity check code for the one word of EPC data 24 [0] (act 205). Subsequently, the reception unit 40 receives the parity check code 57[0] (act 206). The reception unit 40 compares the parity check code obtained by the above calculation with the received parity check code 57 [0] (act 207). When the parity check code obtained by the above calculation matches the received parity check code 57[0], the reception unit 40 processes the data as correct data in which there is no garbled bit (act 207 ‘NO ERRORS’ route and act 208 ‘NOT COMPLETED’ route). The reception unit 40 receives subsequent word of EPC data (act 204). On the other hand, when the parity check is not matched as a result of the comparison in act 207, via act 207 ‘ERROR OCCURRENCE’ route, the reception unit 40 processes the received data as incorrect data including a garbled bit (209), and terminates the reception (act 210).

The reception unit 40 repeats the reception, calculation, comparison, and determination for the number of times equivalent to the number of words in all the EPC data to be received (act 208). Finally, the reception unit 40 receives the CRC-16 data 29 (act 211), and via note A, thereafter calculates the CRC-16 error check (act 212) When a CRC-16 error occurs here, the reception unit 40 processes the received data as incorrect data (act 209) On the other hand, when there is no CRC-16 error, the reception unit 40 processes the data as correct data in which there is no garbled bit (act 213), and terminates the reception (act 210).

In the present embodiment, for example, the reader writer 1 adds the parity check code in unit of one word (2 bytes), this is checked during reception. However, the parity check code may be added and checked not only in unit of one word but also in units of several words. The number of bytes per word is not limited to two bytes.

### Fifth Embodiment

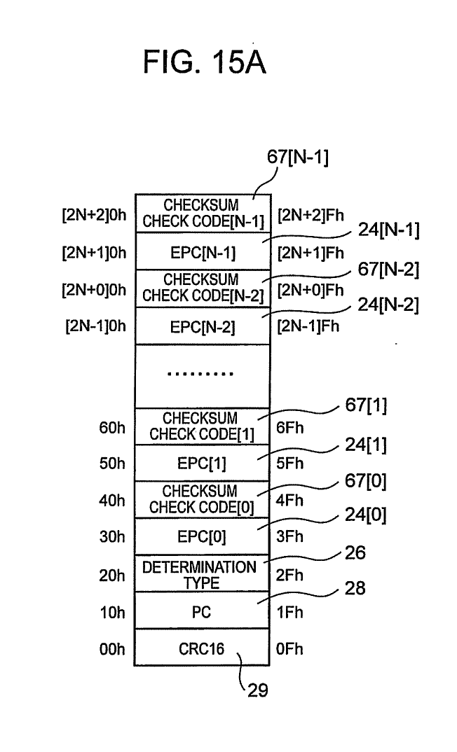

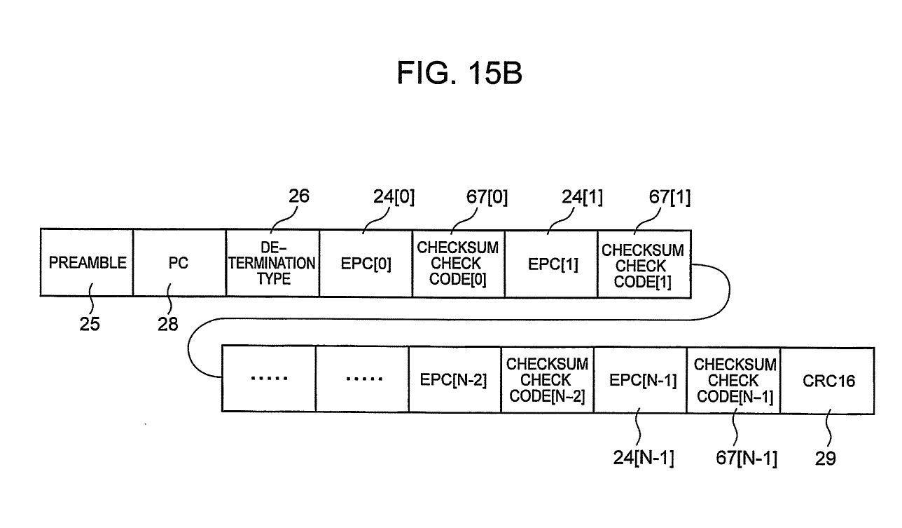

Subsequently, the fifth embodiment will be explained with reference to FIGS. 15 to 17. The fifth embodiment shows an example in which the parity check is performed in unit of one word (2 bytes), and a determination is made as to whether there is any garbled bit.

The wireless tag writing apparatus and the wireless tag reading apparatus according to the present embodiment have substantially the same configuration as the configuration of the reader writer 1 according to the first embodiment unless specifically mentioned.

FIG. 15A illustrates a data structure in a memory 21 in a wireless tag 2. In this example, the memory 21 records the data in unit of one word (2 bytes). The memory 21 stores CRC-16 in the addresses 00h to 0Fh. The wireless tag 2 calculates the CRC-16 when the wireless tag 2 is activated. The wireless tag 2 calculates the CRC-16 for data having a word length specified by a data length PC 28. The reader writer 1 and the wireless tag 2 use the CRC-16 for CRC-16 error check during communication. The memory 21 stores the data length PC 28 in the addresses 10h to 1Fh. The data length PC 28 indicates a word length of the data length PC 28 itself, the determination type code 26, all EPC data 24[0] to 24 [N−1], and all checksum check code 67 [0] to 67 [N−1]. The memory 21 stores the determination type code 26 in addresses 20h to 2Fh. The determination type code 26 represents a determination method for determining whether there is any garbled bit.

The memory 21 stores the first word of EPC data 24 [0] in addresses 30h to 3Fh. The memory 21 stores the calculated checksum check code 67[0] for the first word of EPC data 24[0] in addresses 40h to 4Fh. Likewise, the memory 21 stores the N-th word of EPC data 24 [N−1] in addresses [2N+1] Oh to [2N+1] Fh. The memory 21 stores the checksum check codes 67 [N−1] calculated for the N-th word of EPC data 24 [N−1] in addresses [2N+2] Oh to [2N+2] Fh, respectively.

In this kind of data structure, in reply to a response request such as a read-out command transmitted from the reader writer 1, the wireless tag 2 outputs the preamble 25 and then the data stored in the memory 21 as shown in FIG. 15B.

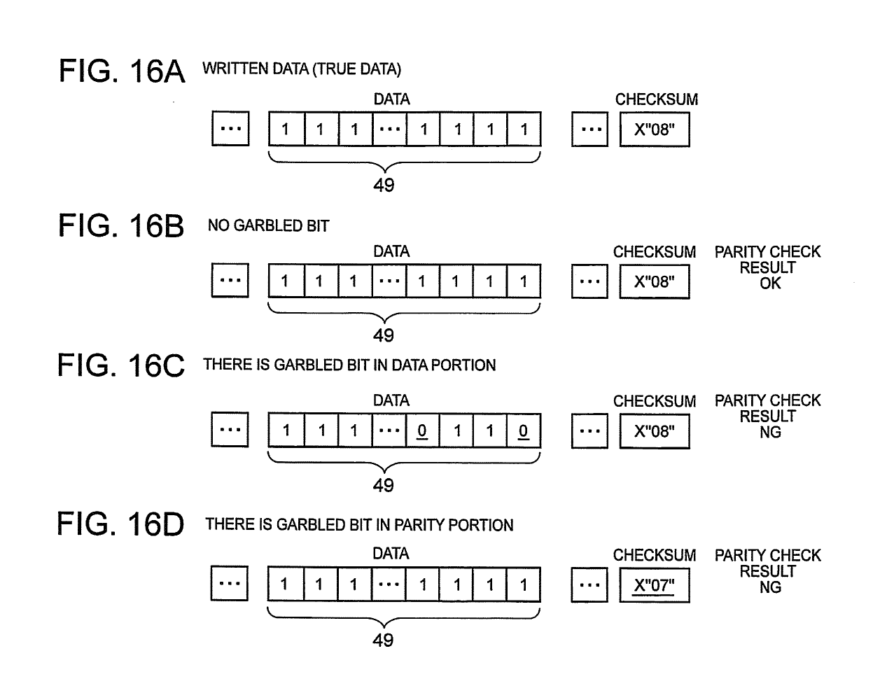

FIG. 16A illustrates an example of a confirmation check method for generating the checksum check code when the reader writer 1 writes data to the wireless tag 2. The reader writer 1 adds the number of bits whose value is 1 to one word of EPC data to be transmitted, and this value is generated as a checksum check code 67 [N−1]. When the reader writer 1 counts the number of bits in the range 49, the results are as follows: the number of bits whose value is 1 is 8, and the value of the checksum calculated by the reader writer 1 is 8.

FIGS. 16B to 16D show examples of a determination method for determining whether there is any garbled bit or not when the reader writer 1 reads data from the wireless tag 2. The reception result in the range 49 of FIG. 16B is as follows. The number of bits whose value is 1 is assumed to be 8, and the value of the checksum is assumed to be 8. As shown in FIG. 16B, when no garbled bit occurs, the checksum check code calculated for one word of the received EPC data 24 matches the checksum check code 67 [N−1] received from the wireless tag 2. The parity check result is OK. On the other hand, when there is a garbled bit occurring in one word of the received EPC data 24, the calculated checksum check code does not match the checksum check code 67[N−1] received from the wireless tag 2. Since the calculated checksum check code does not match the checksum check code 67 [N−1] received from the wireless tag 2, the reader writer 1 determines occurrence of a garbled bit.

FIG. 16C shows a case in which the checksum check code is not matched as a result of a garbled bit occurring in the portion of the EPC data 24. The reception result in the range 49 are as follows. The number of bits whose value is 1 is assumed to be 6, and the value of the checksum is assumed to be 6. The parity check result is NG. FIG. 16D shows a case in which the checksum check is not matched as a result of a garbled bit occurring in the portion of the checksum check code 67 [N−1] received from the wireless tag 2. The reception result in the range 49 are as follows. The number of bits whose value is 1 is assumed to be 8, and the value of the checksum is assumed to be 8. The parity check result is NG.

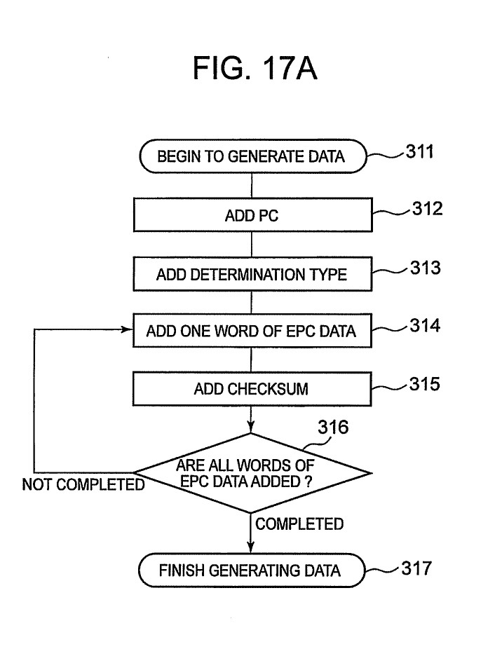

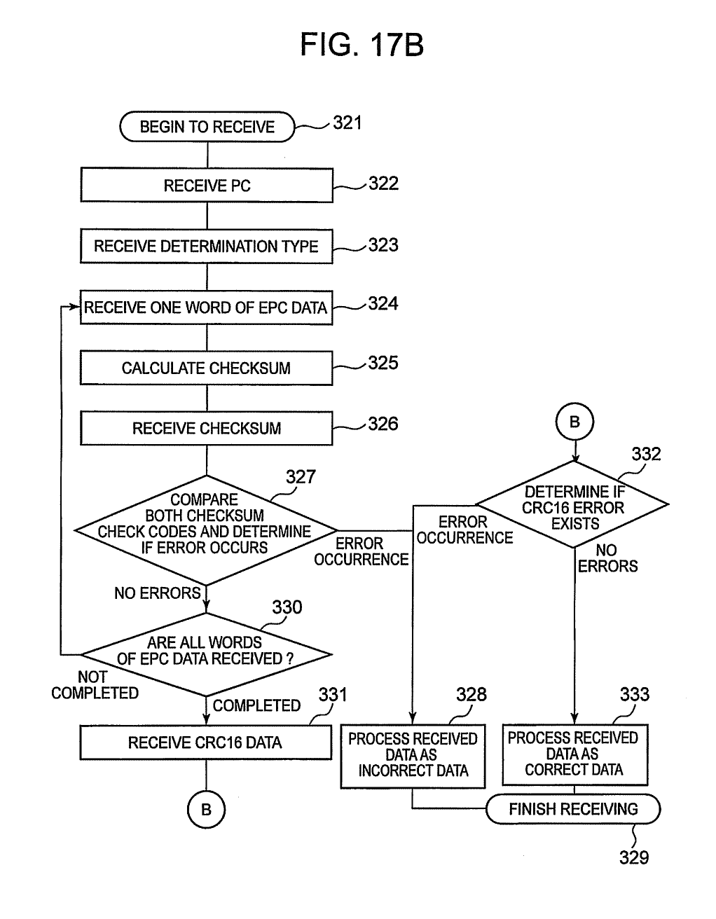

FIG. 17A is a flowchart in which data to be written are generated when the reader writer 1 writes the data to the wireless tag 2.

First, the transmission unit 30 calculates the word length (act 311). The word means each word of the data length PC 28, the determination type code 26, all the EPC data 24 [0] to 24 [N−1], and the checksum check codes 67 [0] to 67 [N−1] corresponding the EPC data 24 [0] to 24 [N−1]. The transmission unit 30 adds, as the data length PC 28, the word length to the data to be transmitted (act 312). Subsequently, the transmission unit 30 adds, to the data, the determination type code 26 serving as the determination method for determining whether there is any garbled bit, in accordance with the determination type specified based on the correspondence table shown in FIG. 3 (act 313).

Subsequently, the transmission unit 30 adds one word of EPC data to the data (act 314). The transmission unit 30 calculates a checksum check code for this one word of EPC data, and adds the calculated checksum check code (act 315). While the transmission unit 30 repeats the addition of the EPC data and the checksum check code to the data for all the word numbers (act 316 ‘NOT COMPLETED’ route), the transmission unit 30 executes acts 314 to 316. When the transmission unit 30 completes generation of the data, via ‘COMPLETED’ route, the transmission unit 30 terminates data generation (act 317).

FIG. 17B is a flowchart in which the reader writer 1 receives response data from the wireless tag 2, and determines whether there is any garbled bit.

First, the reception unit 40 receives the data length PC 28 from the wireless tag 2 (acts 321, 322), and determines the word length of the data received from the wireless tag 2. Subsequently, the reception unit 40 receives the determination type code 26 (act 323), and selects a determination method for determining whether there is any garbled bit in accordance with the correspondence table of FIG. 3. Subsequently, the reception unit 40 receives one word of EPC data 24 (act 324). After the reception unit 40 receives the one word of EPC data 24, the reception unit 40 calculates a checksum check code for this one word of EPC data 24 (act 325). Subsequently, the reception unit 40 receives the checksum check code from the wireless tag 2 (act 326). The reception unit 40 compares the checksum check code obtained from calculation with the checksum check code received from the wireless tag 2 (act 327). When the checksum check code obtained from calculation matches the checksum check code received from the wireless tag 2, via act 330 ‘NOT COMPLETED’ route, the reception unit 40 receives one subsequent word of EPC data 24 (act 324).

On the other hand, when the parity check is not matched as a result of the comparison in act 327, via ‘ERROR OCCURRENCE’ route, the reception unit 40 processes the received data as incorrect data including a garbled bit (act 328), and terminates the reception (act 329). The reception unit 40 repeats the comparison between the checksum check codes for the number of times equivalent to the number of words in all the EPC data to be received (act 330). After the reception unit 40 receives all the EPC data, via ‘COMPLETED’ route, finally, the reception unit 40 receives the CRC-16 (act 331). Thereafter, via note B, the reception unit 40 calculates the CRC-16 error check (act 332). When a CRC-16 error occurs here, via ‘ERROR OCCURRENCE’, the reception unit 40 processes the received data as incorrect data (act 328). On the other hand, when there is no CRC-16 error, the reception unit 40 processes the data as correct data in which there is no garbled bit (act 333), and terminates the reception.

In the present embodiment, for example, the checksum check codes are added in unit of one word (2 bytes), and this is checked during reception. However, the checksum check codes may be added and checked not only in unit of one word but also in units of several words. The number of bytes per word is not limited to two bytes.

### Sixth Embodiment

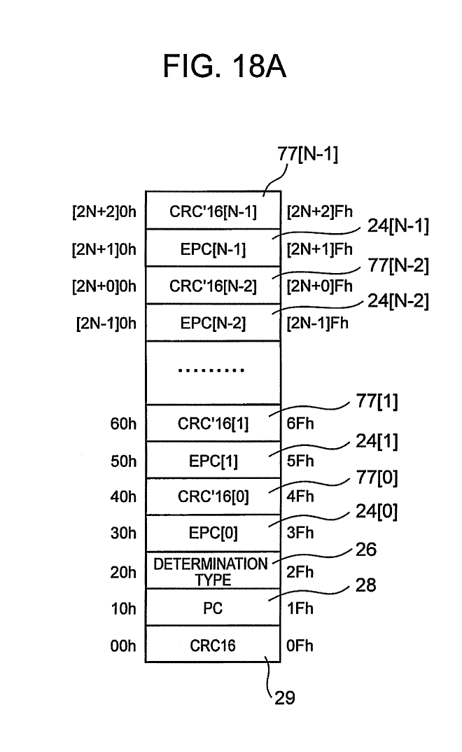

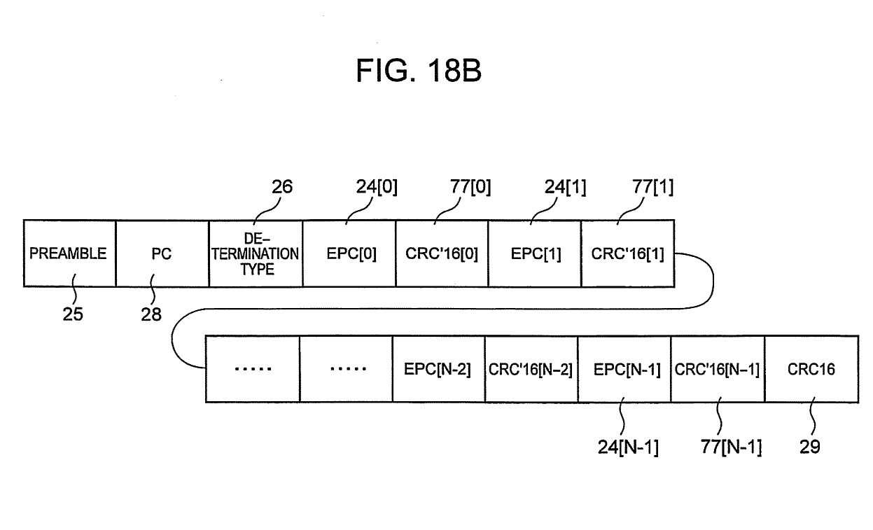

Further, the sixth embodiment will be explained with reference to FIGS. 18 to 20. The fifth embodiment shows an example in which a CRC 16 check is calculated in unit of one word (2 bytes), and a determination is made as to whether there is any garbled bit.

The wireless tag writing apparatus and the wireless tag reading apparatus according to the present embodiment have substantially the same configuration as the configuration of the reader writer 1 according to the first embodiment unless specifically mentioned.

In this case, the description of CRC′ 16 is used such that it is distinguished from the CRC 16 which the wireless tag 2 calculates for data in the memory 12 of the wireless tag 2 during activation.

FIG. 18A illustrates a data structure in a memory 21 in a wireless tag 2. In this example, the memory 21 records the data in unit of one word (2 bytes). The memory 21 stores CRC-16 data 29 in the addresses 00h to 0Fh. The wireless tag 2 calculates the CRC-16 data 29 when the wireless tag 2 is activated. The reader writer 1 and the wireless tag 2 calculate the CRC-16 data 29 for data having a word length specified by a data length PC 28. The reader writer 1 and the wireless tag 2 use the CRC-16 data 29 for CRC-16 error check during communication. The memory 21 stores the data length PC 28 in the addresses 10h to 1Fh. The data length PC 28 indicates a word length of the data length PC 28 itself, the determination type code 26, EPC data 24 [0] to 24 [N−1], and CRC′ 16 data 77 [0] to 77 [N1]. The memory 21 stores the determination type code 26 in addresses 20h to 2Fh. The determination type code 26 represents a determination method for determining whether there is any garbled bit. The memory 21 includes the first word of EPC data 24 [0] in addresses 30h to 3Fh. The memory 21 stores the calculated CRC′ 16 data 77 [0] for the first word of EPC data 24 [0] in addresses 40h to 4Fh. Likewise, the memory 21 stores the N-th word of EPC data 24 [N−1] in addresses [2N+1] Oh to [2N+1] Fh. The memory 21 stores the CRC′ 16 data 77 [N−1] calculated for the N-th word of EPC data 24 [N−1] in addresses [2N+2] Oh to [2N+2] Fh.

In this kind of data structure, in reply to a response request such as a read-out command transmitted from the reader writer 1, the wireless tag 2 outputs the preamble 25 and then the data stored in the memory 21 as shown in FIG. 18B.

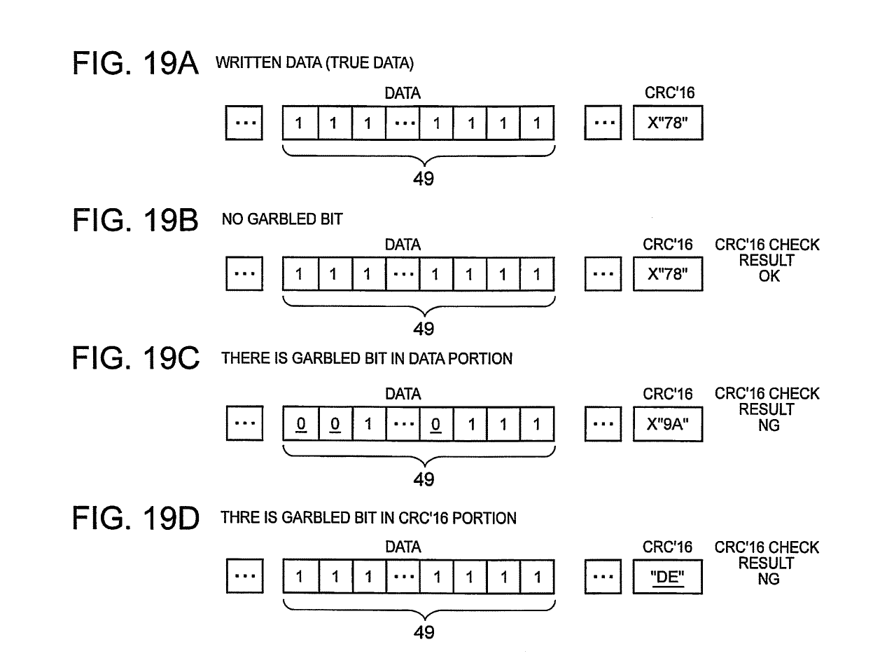

FIG. 19A illustrates an example of a confirmation check method for generating a CRC′ 16 when the reader writer 1 writes data to the wireless tag 2. The reader writer 1 calculates a CRC′ 16 for one word of EPC data to be transmitted. In FIG. 19A, in a range 49, a value of CRC′ 16 is assumed to be X″78″.

FIGS. 19B to 19D show examples of a determination method for determining whether there is any garbled bit or not when the reader writer 1 reads data from the wireless tag 2. The reception result in the range 49 of FIG. 19B is assumed to be as follows. The value of the CRC′ 16 is assumed to be X″78″. As shown in FIG. 19B, when no garbled bit occurs, the CRC′ 16 calculated for one word of the received EPC data matches the received CRC′ 16. On the other hand, when there is a garbled bit occurring in one word of the received EPC data, the calculated CRC′ 16 does not match the received CRC′ 16. Therefore, the reader writer 1 determines that there is a garbled bit.

FIG. 19C shows a case in which the CRC′ 16 is not matched as a result of a garbled bit occurring in the portion of the EPC data. In FIG. 19C, in a range 49, a value of CRC′ 16 is assumed to be X″BC″. The CRC′ 16 check result is NG. FIG. 19D shows a case in which the CRC′ 16 is not matched as a result of a garbled bit occurring in the portion of the CRC′ 16 received from the wireless tag 2. In FIG. 19D, in a range 49, a value of CRC′ 16 is assumed to be X″78″. The CRC′ 16 check result is NG.

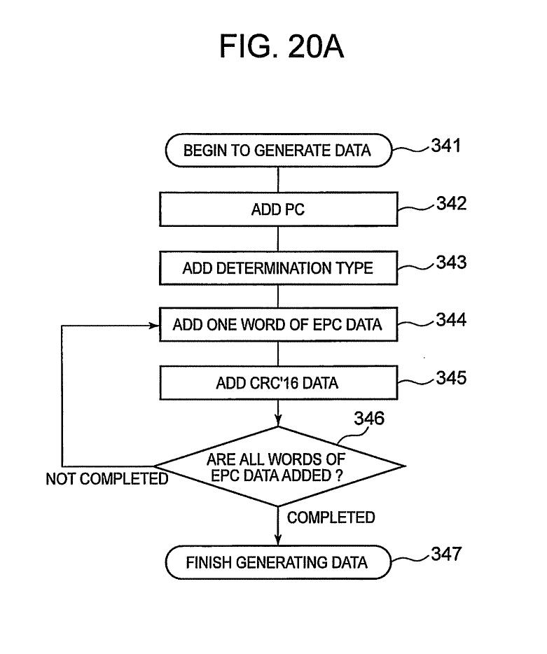

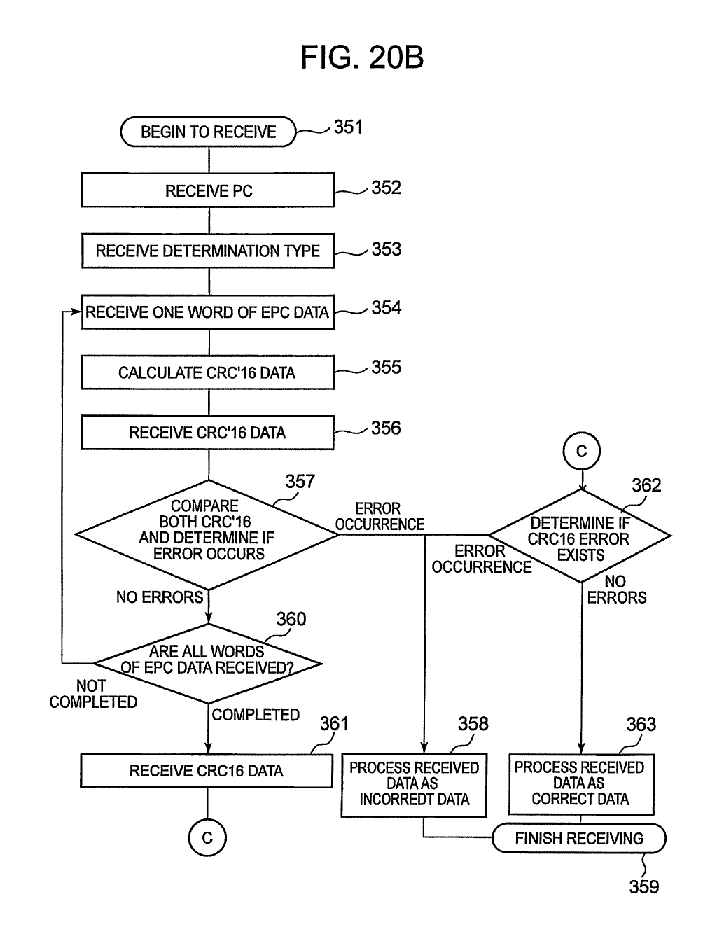

FIG. 20A is a flowchart in which data to be written are generated when the reader writer 1 writes the data to the wireless tag 2.

First, the transmission unit 30 calculates the word length (act 341, 342). The word means the data length PC 28, the determination type code 26, the EPC data 24 [0] to 24 [N−1], and the CRC′ 16 data 77 [0] to 77 [N−1]. The transmission unit 30 adds, as the data length PC 28, the word length to the data to be transmitted (act 342). Subsequently, the transmission unit 30 adds the determination type code 26 serving as the determination method for determining whether there is any garbled bit, in accordance with the determination type specified based on the correspondence table shown in FIG. 3 (act 343). Subsequently, the transmission unit 30 adds one word of EPC data to the data (act 344). Subsequently, the transmission unit 30 calculates a CRC′ 16 for the one word of EPC data, and adds the calculated CRC′ 16 to the data (act 345). While the transmission unit 30 repeats the addition of the EPC data, the calculation of the CRC′ 16, and the addition of the CRC′ 16 to the data for all the word numbers (act 346 ‘NOT COMPLETED’ route and acts 344, 345). When the transmission unit 30 completes the addition, via ‘COMPLETED’ route, the transmission unit 30 terminates generation of the data (act 347).

FIG. 20B is a flowchart in which the reader writer 1 receives response data from the wireless tag 2, and determines whether there is any garbled bit.

First, the reception unit 40 receives the data length PC 28 (acts 351, 352). The reception unit 40 determines the word length of the data to be replied from the wireless tag 2. Subsequently, the reception unit 40 receives the determination type code 26 (act 352). The reception unit 40 selects a determination method for determining whether there is any garbled bit in accordance with the correspondence table of FIG. 3. Subsequently, the reception unit 40 receives one word of EPC data (act 354). After the reception unit 40 receives the one word of EPC data, the reception unit 40 calculates a CRC′ 16 for this one word of EPC data (act 355).

Subsequently, the transmission unit 30 receives the CRC′ 16 from the wireless tag 2 (act 356). The reception unit 40 compares the CRC′ 16 obtained from the calculation and the received CRC′ 16 (act 357). The reception unit 40 determines that there are no errors, via ‘NO ERRORS’ route, the reception unit 40 executes process in act 360. While the CRC′ 16 obtained from the calculation matches the received CRC′ 16, the reception unit 40 processes the received data as correct data including no garbled bit, via act 360 ‘NOT COMPLETED’ route, the reception unit 40 receives one subsequent word of the EPC data (act 354). On the other hand, when the CRC′ 16 is not matched as a result of the comparison in act 357, via ‘ERROR OCCURRENCE) route, the reception unit 40 processes the received data as incorrect data including a garbled bit (act 358), and terminates the reception (act 359).

The reception unit 40 repeats the match determination between the CRCs' 16 for the number of times equivalent to the number of all the words to be received (act 360). Via act 360 ‘COMPLETED’ route, finally, the reception unit 40 receives the CRC-16 (act 361). After the reception, via note C, the reception unit 40 calculates a CRC-16 error check (act 362). When a CRC-16 error occurs here, via ‘ERROR OCCURRENCE’, the reception unit 40 processes the received data as incorrect data (act 358). On the other hand, when there is no CRC-16 error, the reception unit 40 processes the data as correct data in which there is no garbled bit (act 363), and terminates the reception (act 359).

In the present embodiment, for example, the CRC′ 16 is added in unit of one word (2 bytes), and this is checked during reception. However, the CRC′ 16 may be added and checked not only in unit of one word but also in units of several words. The number of bytes per word is not limited to two bytes.

### Seventh Embodiment

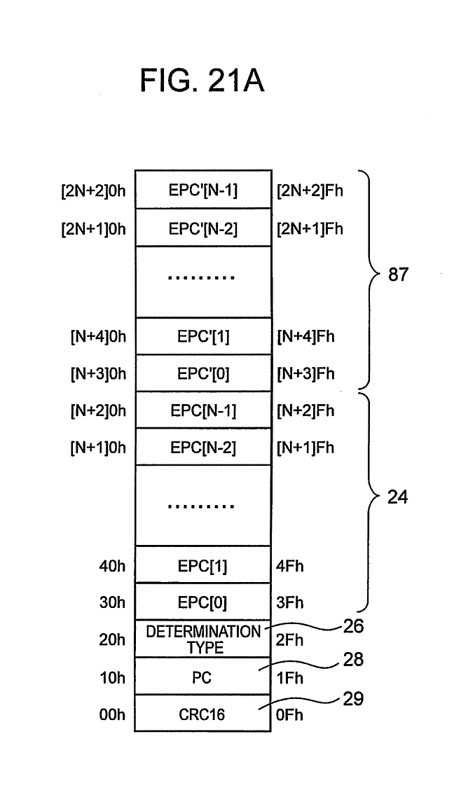

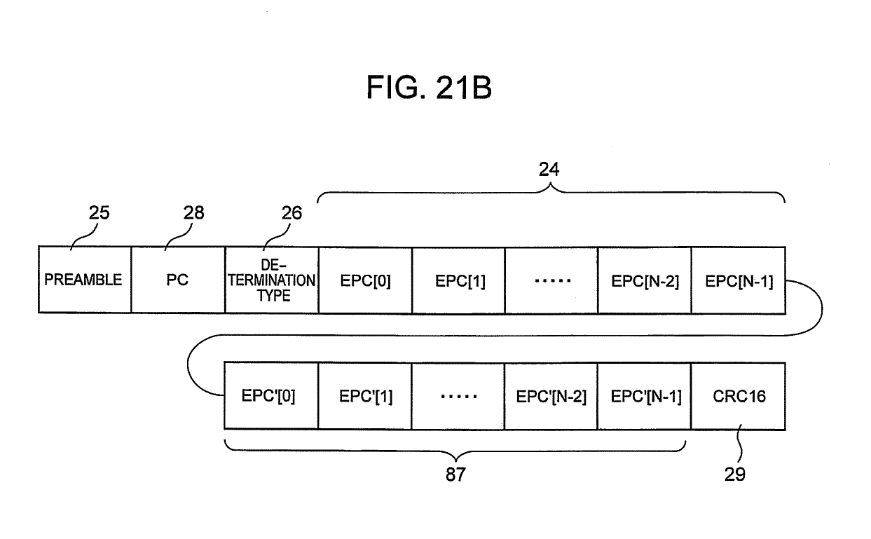

Subsequently, the seventh embodiment will be explained with reference to FIGS. 21 to 23. The seventh embodiment shows an example in which data are mirrored, and a determination is made as to whether there is any garbled bit by mirror data check.

The wireless tag writing apparatus and the wireless tag reading apparatus according to the present embodiment have substantially the same configuration as the configuration of the reader writer 1 according to the first embodiment unless specifically mentioned.

FIG. 21A illustrates a data structure in a memory 21 in a wireless tag 2. In this example, the memory 21 records the data in unit of one word (2 bytes). The memory 21 stores CRC-16 data 29 in the addresses 00h to 0Fh. The wireless tag 2 calculates the CRC-16 data 29 when the wireless tag 2 is activated. The reader writer 1 and the wireless tag 2 calculate the CRC-16 data 29 for data having a word length specified by a data length PC 28. The reader writer 1 and the wireless tag 2 use the CRC-16 data 29 for CRC-16 error check during communication. The memory 21 stores the data length PC 28 in addresses 10h-1Fh. The data length PC 28 indicates a word length of the data length PC 28 itself, the determination type code 26, all EPC data 24 [0] to 24 [N−1] and all mirror data (hereinafter referred to as EPC′ data) 87 [0] to 87 [N−1]. The memory 21 stores the determination type code 26 representing a determination method for determining whether there is any garbled bit, in addresses 20h to 2Fh.

The memory 21 stores the EPC data 24 [0] to 24 [N−1] having N words in addresses 30h to [N+2] Fh. The memory 21 stores the mirror data (EPC′ data) 87 [0] to 87 [N−1] having N words, which are the same as the EPC data, in addresses [N+3] 0h to [2N+2] Fh.

In this kind of data structure, in reply to a response request such as a read-out command transmitted from the reader writer 1, the wireless tag 2 outputs the preamble 25 and then the data stored in the memory 21 as shown in FIG. 21B.

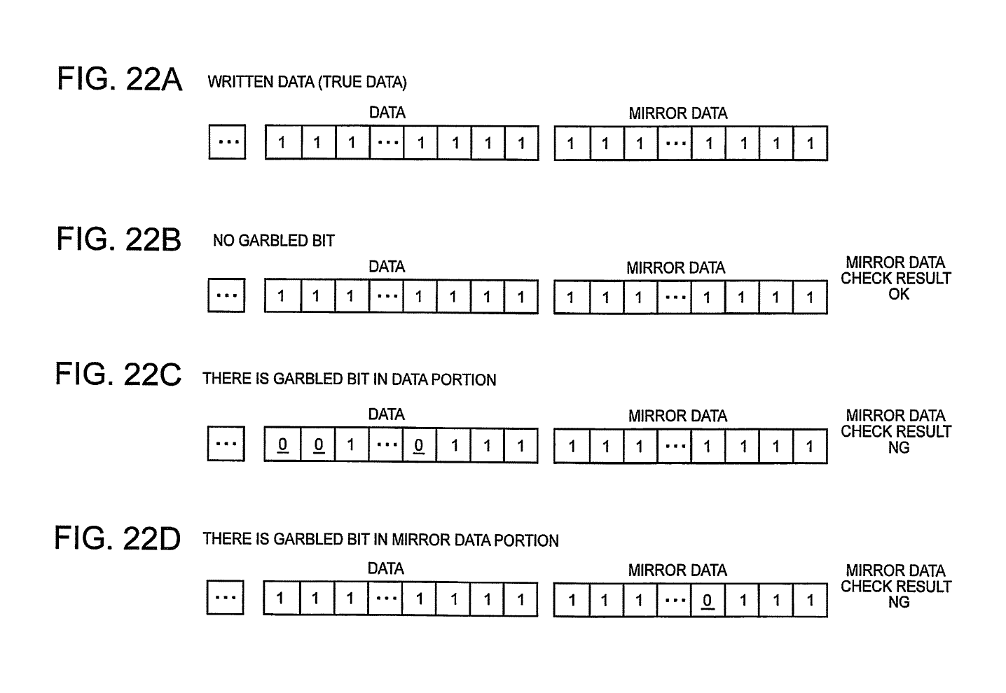

FIG. 22A illustrates an example of a confirmation check method for generating mirror data when the reader writer 1 writes data to the wireless tag 2. The reader writer 1 generates, as mirror data, the same EPC′ data having N words as the EPC data for the EPC data having N words to be transmitted.

FIGS. 22B to 22D show examples of a determination method for determining whether there is any garbled bit or not when the reader writer 1 reads data from the wireless tag 2.

As shown in FIG. 22B, when no garbled bit occurs, the received EPC data 24 match the received EPC′ data 87. The mirror data check result is OK. On the other hand, when there is a garbled bit occurring in the received EPC data 24, the EPC data 23 received from the wireless tag 2 do not match the EPC′ data. Therefore, the reader writer 1 determines that there is a garbled bit.

FIG. 22C shows an example in which the EPC data 24 do not match the EPC′ data 87 as a result of a garbled bit occurring in the portion of the EPC data 24. The mirror data check result is NG. FIG. 22D shows an example in which the EPC data 24 do not match the EPC′ data 87 as a result of a garbled bit occurring in the portion of the EPC′ data 87. The mirror data check result is NG.

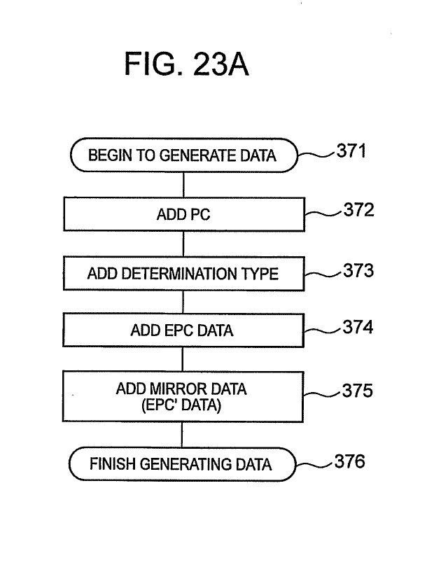

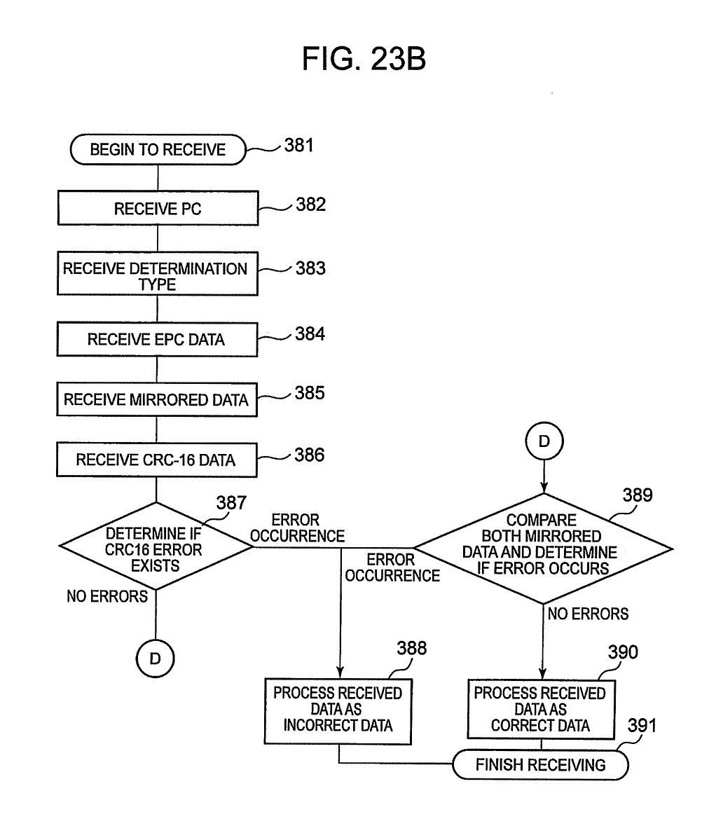

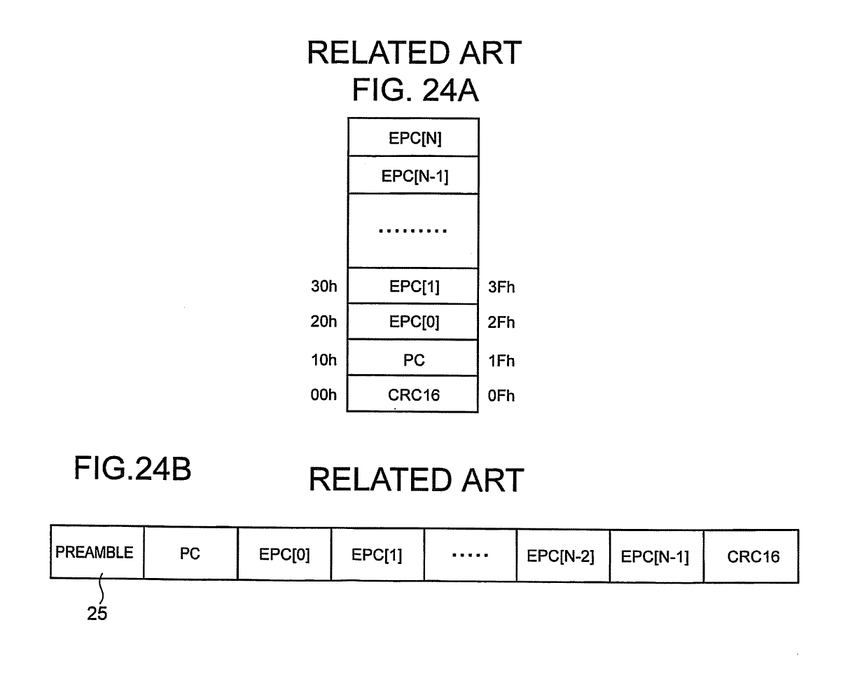

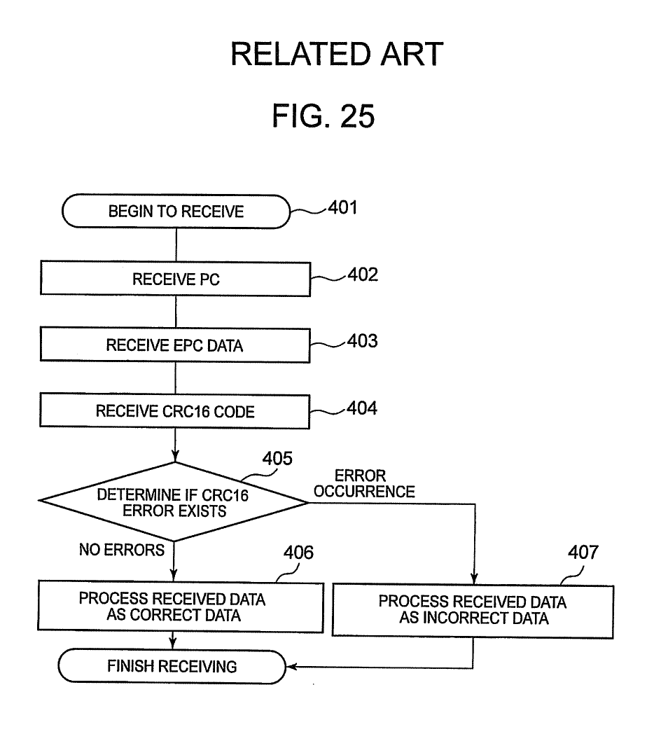

FIG. 23A is a flowchart in which data to be written are generated when the reader writer 1 writes the data to the wireless tag 2.

First, the transmission unit 30 calculates a word length of the data length PC 28, the determination type code 26, the EPC data 24, and EPC′ data 87. The transmission unit 30 adds, as the data length PC 28, the word length to the data to be transmitted (acts 371, 372). Subsequently, the transmission unit 30 adds, to the data, the determination type code 26 serving as the determination method for determining whether there is any garbled bit, in accordance with the determination type specified based on the correspondence table shown in FIG. 3 (act 373).

Subsequently, the transmission unit 30 adds the EPC data 24 to the data (act 374). Subsequently, the transmission unit 30 adds the EPC′ data 87 serving as the mirror data to the data (act 375), and terminates generation of the data (act 376).

FIG. 23B is a flowchart in which the reader writer 1 receives response data from the wireless tag 2, and determines whether there is any garbled bit.

First, the reception unit 40 receives the data length PC 28 (acts 381, 382). The reception unit 40 determines the word length of the data to be replied from the wireless tag 2. Subsequently, the reception unit 40 receives the determination type code 26 (act 383). The reception unit 40 selects a determination method for determining whether there is any garbled bit in accordance with the correspondence table of FIG. 3. Subsequently, the reception unit 40 receives the EPC data 24 (act 384). After the reception unit 40 receives the EPC data 24, the reception unit subsequently receives the EPC′ data 87 serving as the mirror data (act 385). Finally, the reception unit 40 receives the CRC-16 (act 386).

When the reception unit 40 receives data up to the CRC-16 from the wireless tag 2, the reception unit 40 calculates a CRC-16 error check (act 387). When a CRC-16 error occurs here, via ‘ERROR OCCURRENCE’ route, the reception unit 40 processes the received data as incorrect data (act 388). On the other hand, when there is no CRC-16 error in act 387, via note D, the reception unit 40 compares the EPC data 24 with the EPC′ data 87 (act 389). When the EPC data 24 match the EPC′ data 87, via ‘NO ERRORS’ route, the reception unit 40 processes the received data as correct data including no garbled bit (act 390), and terminates the reception (act 391). On the other hand, when the EPC data 24 do not match the EPC′ data 87, the reception unit 40 processes the received data as incorrect data including a garbled bit (act 388), and terminates the reception. In this case, in the above embodiments, the data length PC 28 and the determination type code 26 are in separate words (2 bytes). Alternatively, both of them may be accommodated in the same word. For example, the determination type code 26 may be included in the data length PC 28, the length information of the data representing the word length may be stored in a high byte of the data length PC 28, and the determination type code may be included in a low byte thereof.

Further, when the determination type code is set as X″00″, it is possible to employ the communication method according to the related art in which a determination is not made as to whether there is any garbled bit. More specifically, in the wireless tag writing apparatus according to the embodiment, the determination type code 26 can switch whether or not to execute calculation using a check code for checking confirmation determination according to the determination type code 26. In the wireless tag reading apparatus according to the embodiment, the determination type code 26 can switch whether or not to execute generation of a second check code for checking confirmation determination.

According to the wireless tag writing apparatus, the wireless tag reading apparatus, the data writing/reading method using the wireless tag writing/reading apparatus according to at least one embodiment explained above, when there is a garbled bit in the memory of the wireless tag, the data including the garbled bit can be determined as incorrect data.

The embodiments of the present invention have been hereinabove explained. However, these embodiments are shown as examples, and are not intended to limit the scope of the invention. These new embodiments can be embodied in various other forms, and various kinds of omissions, replacements, and changes can be made without deviating from the gist of the invention. These embodiments and the modifications thereof are included in the scope and the gist of the invention, and are included in the invention described in the claims and the scope equivalent thereto.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. A wireless tag writing apparatus comprising:
a generation unit configured to generate an identification code to be written in a wireless tag having a memory storing data, the identification code identifying an object attached with the wireless tag;
an adding unit configured to calculate the identification code according to a determination type code representing a type of a determination method for confirming whether there is any garbled bit occurring in the identification code, and add a generated check code resultant from calculation according to the determination method to the identification code; and
a communication unit configured to communicate with the wireless tag, and write the identification code, the determination type code, and the check code to the memory of the wireless tag.

2. The wireless tag writing apparatus of claim 1, wherein the adding unit adds the determination type code and length information representing a length of the determination type code and the identification code to the identification code.

3. The wireless tag writing apparatus of claim 1, wherein the type of the determination method used by the adding unit is any one of a parity check, a checksum check, a CRC (Cyclic Redundancy Check) check, and a mirror data check.

4. The wireless tag writing apparatus of claim 2, wherein the type of the determination method used by the adding unit is any one of a parity check, a checksum check, a CRC check, and a mirror data check.

5. The wireless tag writing apparatus of claim 1, wherein the memory of the wireless tag stores the identification code, the determination type code, and the check code, and
the wireless tag includes an output unit that outputs the identification code, the determination type code, and the check code stored in the memory in response to a read request transmitted from the wireless tag writing apparatus.

6. The wireless tag writing apparatus of claim 1, wherein a memory of the wireless tag includes a first region storing parity bits of error detection code defined in advance according to an air interface specification and a second region separated from the first region and storing the identification code, and
the adding unit adds the determination type code and the check code to the second region.

7. The wireless tag writing apparatus of claim 2, wherein a memory of the wireless tag includes a first region storing parity bits of error detection code defined in advance according to an air interface specification and a second region separated from the first region and storing the identification code, and
the adding unit adds the determination type code, the check code, and the length information to the second region.

8. The wireless tag writing apparatus of claim 1, wherein the adding unit switches, on the basis of the determination type code, whether or not to execute calculation of the identification code according to the determination type code.

9. A wireless tag reading apparatus comprising:
a communication unit configured to communicate with a wireless tag having a memory storing data, and read information from the memory;
a reading unit configured to read, from the wireless tag by received data of the communication unit,
an identification code for identifying an object attached with the wireless tag,
a determination type code representing a type of a determination method for confirming whether there is any garbled bit occurring in the identification code in the memory, and
a first check code resultant from calculation by the wireless tag generated from the identification code according to the determination type code;
a generation unit configured to generate a second check code from the identification code read from the reading unit, on the basis of the type represented by the determination type code read by the reading unit; and
a determination unit configured to determine correctness of the identification code by comparing the second check code generated by the generation unit and the first check code read by the reading unit.

10. The wireless tag reading apparatus of claim 9, wherein the reading unit reads the identification code, the determination type code, and length information representing a length of the identification code and the determination type code, and the generation unit generates the second check code from the length information.

11. The wireless tag reading apparatus of claim 10, wherein the type of the determination method read by the reading unit is any one of a parity check, a checksum check, a CRC check, and a mirror data check.

12. The wireless tag reading apparatus of claim 9, wherein the type of the determination method read by the reading unit is any one of a parity check, a checksum check, a CRC check, and a mirror data check.

13. The wireless tag reading apparatus of claim 9, wherein the memory of the wireless tag stores the identification code, the determination type code, and the check code, and
the wireless tag includes an output unit that outputs the first check code stored in the memory in response to a read request transmitted from the wireless tag reading apparatus.

14. The wireless tag reading apparatus of claim 9, wherein a memory of the wireless tag includes a first region storing parity bits of error detection code defined in advance according to an air interface specification and a second region separated from the first region and storing the identification code, and
the adding unit reads the determination type code and the check code from the second region.

15. The wireless tag reading apparatus of claim 10, wherein a memory of the wireless tag includes a first region storing parity bits of error detection code defined in advance according to an air interface specification and a second region separated from the first region and storing the identification code, and
the reading unit reads the determination type code, the check code, and the length information from the second region.

16. The wireless tag reading apparatus of claim 9, wherein the generation unit switches, on the basis of the determination type code, whether or not to execute generation of the second check code.

17. A data writing/reading method performed by a wireless tag writing/reading apparatus, comprising:
specifying a type of a determination method for confirming whether there is any garbled bit occurring in the identification code for identifying an object attached with the wireless tag having a memory storing data;
generating a check code from the identification code on the basis of the specified type;
adding the determination type code representing the specified type and the generated check code to the identification code, and transmitting the identification code, the determination type code and the check code to the wireless tag;
reading a first check code corresponding to the identification code, the determination type code, and the first check code in the memory from the wireless tag;
generating a second check code from the read identification code on the basis of the determination type represented by the read determination type code; and
determining correctness of the identification code by comparing the generated second check code with the read first check code.

18. The method of claim 17, wherein in the step of transmitting the determination type code and the identification code to the wireless tag, adding the identification code and length information representing a length of the determination type code and the identification code, to the identification code.

19. The method of claim 17, wherein the type of the determination method is anyone of a parity check, a checksum check, a CRC check, and a mirror data check.

20. The method of claim 17, wherein in the step of transmitting the determination type code and the identification code to the wireless tag, switching whether or not to execute calculation of the identification code according to the determination type code on the basis of the determination type code.
